(19) United States
(12) Patent Application Publication
(10) Pub. No.: US 2022/0224956 A1
(43) Pub. Date: Jul. 14, 2022

(54) INFORMATION PROCESSING DEVICE, INFORMATION PROCESSING METHOD, AND SYSTEM

(71) Applicant: FUJITSU LIMITED, Kawasaki-shi (JP)

(72) Inventors: MIHO KAWANO, Hamamatsu (JP); Takahisa Suzuki, Yokohama (JP)

(73) Assignee: FUJITSU LIMITED, Kawasaki-shi (JP)

(21) Appl. No.: 17/486,982

(22) Filed: Sep. 28, 2021

(30) Foreign Application Priority Data
Jan. 13, 2021 (JP) 2021-003322

(51) Int. Cl. H04N 21/24; G06F 9/48; G06N 5/04

(52) U.S. Cl. CPC H04N 21/24; G06N 5/04; G06F 9/4887

(57) ABSTRACT

An information processing device performs first processing including: acquiring, for each of a plurality of processing to be executed using different models, profile information enabling specification of a time needed to prepare for execution of that processing and a time needed to execute that processing; and determining an arrangement pattern of the plurality of processing for one or more arithmetic units, the arrangement pattern being capable of maximizing execution efficiency for the plurality of processing, by searching for a node from a root to a leaf such that the execution of that processing is able to be completed within a time limit, in a tree structure where the node representing a position where processing included in the plurality of processing is arranged is connected from the root to a lower level, and formed such that a larger number of pieces of processing has been arranged as a hierarchy is deeper.

### CROSS-REFERENCE TO RELATED APPLICATION

This application is based upon and claims the benefit of priority of the prior Japanese Patent Application No. 2021-3322, filed on Jan. 13, 2021, the entire contents of which are incorporated herein by reference.

### FIELD

The embodiments discussed herein are related to an information processing device, an information processing method, and a system.

### BACKGROUND

Conventionally, there are cases where an inference process for processing a moving image is executed on a server equipped with a graphics processing unit (GPU). In a case where a plurality of servers equipped with GPUs is present and a plurality of inference processes is present, a management server determines which inference process is to be arranged and executed on which server. In particular, in a system with a relatively small number of servers and limited computing resources, it is desired to determine which inference process is favorably arranged and executed on which server, and determine which inference process is to be arranged and executed on which server.

As an existing technique, for example, there is a technique of collecting resource information from a coprocessor, calculating a processing time, and allocating an inference process on the basis of the calculated processing time. Furthermore, there is a technique of detecting whether a processing delay has occurred in an inference process in an inference processing device and selecting another inference processing device capable of executing the same inference process as the inference processing device in which the processing delay has occurred, for example. Furthermore, there is a technique of predicting a first data processing unit or a second data processing unit having a shorter processing time and creating a processing distribution rule, for example.

Examples of the related art include as follows: U.S. Patent Application Publication No. 2020/0210866; Japanese Laid-open Patent Publication No. 2020-135061; and Japanese Laid-open Patent Publication No. 2015-108993.

### SUMMARY

According to an aspect of the embodiments, an information processing device includes: a memory; and a processor coupled to the memory, the processor being configured to perform first processing, the first processing including: acquiring, for each processing of a plurality of pieces of processing to be executed using different models, profile information that enables specification of a time needed to prepare for execution of that processing and a time needed to execute that processing; and determining, in arranging the plurality of pieces of processing for one or more arithmetic units by using the acquired profile information, an arrangement pattern of the plurality of pieces of processing for the one or more arithmetic units, the arrangement pattern being capable of maximizing execution efficiency for the plurality of pieces of processing, the determining of the arrangement pattern including searching for a node from a root to a leaf such that the execution of the each processing is able to be completed within a time limit set for that processing, in a tree structure in which the node that represents a position where processing included in the plurality of pieces of processing is arranged is connected from the root to a lower level, the three structure being formed such that a larger number of pieces of processing has been arranged as a hierarchy is deeper.

The object and advantages of the invention will be realized and attained by means of the elements and combinations particularly pointed out in the claims.

It is to be understood that both the foregoing general description and the following detailed description are exemplary and explanatory and are not restrictive of the invention.

### BRIEF DESCRIPTION OF DRAWINGS

FIG. 1 is an explanatory diagram illustrating an example of an information processing method according to an embodiment;

FIG. 2 is an explanatory diagram illustrating an example of an information processing system 200;

FIG. 3 is a block diagram illustrating a hardware configuration example of an information processing device 100;

FIG. 4 is an explanatory diagram illustrating an example of content stored in an inference execution request management table 400;

FIG. 5 is an explanatory diagram illustrating an example of content stored in an execution device resource information management table 500;

FIG. 6 is an explanatory diagram illustrating an example of content stored in an inference model execution profile management table 600;

FIG. 7 is an explanatory diagram illustrating an example of content stored in an allocation result management table 700;

FIG. 8 is an explanatory diagram illustrating an example of content stored in a required time excess information management table 800;

FIG. 9 is a block diagram illustrating a hardware configuration example of an execution device 201;

FIG. 10 is a block diagram illustrating a hardware configuration example of an information collection device 202;

FIG. 11 is a block diagram illustrating a functional configuration example of the information processing system 200;

FIG. 12 is a block diagram illustrating a specific functional configuration example of the information processing system 200;

FIG. 13 is an explanatory diagram (No. 1) illustrating an operation example of the information processing system 200;

FIG. 14 is an explanatory diagram (No. 2) illustrating an operation example of the information processing system 200;

FIG. 15 is an explanatory diagram (No. 3) illustrating an operation example of the information processing system 200;

FIG. 16 is an explanatory diagram (No. 4) illustrating an operation example of the information processing system 200;

FIG. 17 is an explanatory diagram (No. 5) illustrating an operation example of the information processing system 200;

FIG. 18 is an explanatory diagram (No. 6) illustrating an operation example of the information processing system 200;

FIG. 19 is an explanatory diagram (No. 7) illustrating an operation example of the information processing system 200;

FIG. 20 is a flowchart illustrating an example of an overall processing procedure;

FIG. 21 is a flowchart (No. 1) illustrating an example of an allocation pattern determination processing procedure; and

FIG. 22 is a flowchart (No. 2) illustrating an example of an allocation pattern determination processing procedure.

### DESCRIPTION OF EMBODIMENTS

However, in the existing technique, it is difficult to execute a plurality of inference processes efficiently using a plurality of servers. For example, since it is not possible to appropriately determine which inference process is favorably arranged and executed on which server, it is not possible to execute a plurality of inference processes efficiently using a plurality of servers.

In one aspect, an object of the present embodiment is to execute a plurality of pieces of processing efficiency using one or more arithmetic units.

Hereinafter, embodiments of an information processing device, an information processing method, and a system will be described in detail with reference to the drawings.

### Example of Information Processing Method According to Embodiment

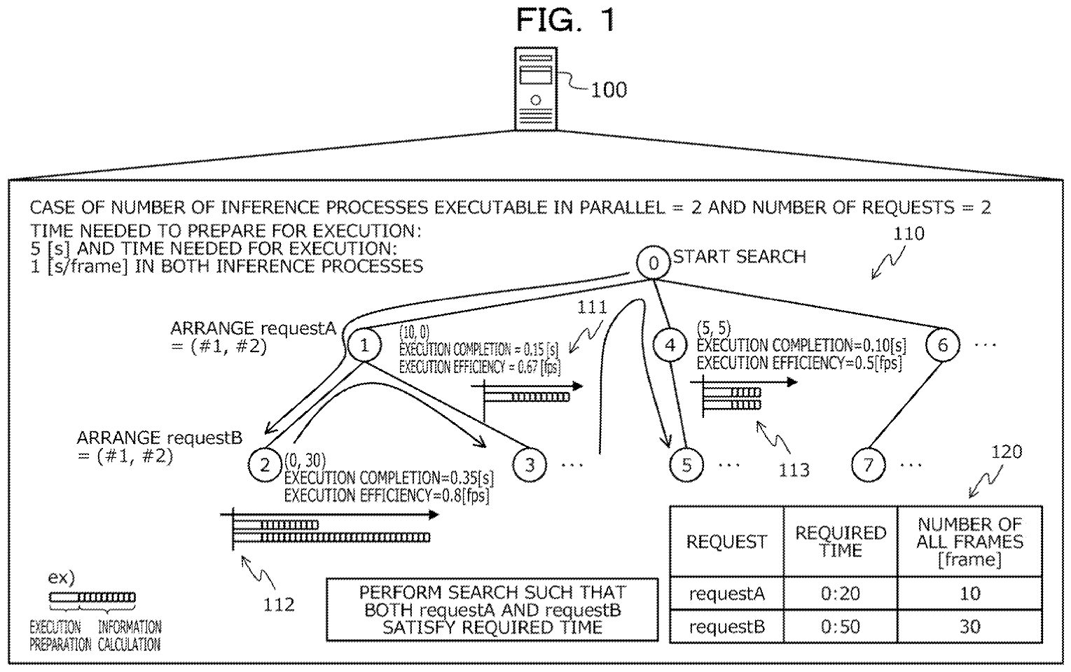

FIG. 1 is an explanatory diagram illustrating an example of an information processing method according to an embodiment. An information processing device 100 is a computer for determining an appropriate arrangement pattern for arranging a plurality of pieces of processing for one or more arithmetic units.

Here, the processing is to perform a predetermined operation regarding a moving image, for example. Specifically, the processing is to perform a predetermined operation regarding a frame of the moving image. The predetermined operation is, for example, image processing. Specifically, the predetermined operation is detection processing of an object reflected in an image. The processing is, more specifically, an inference process. The processing may not be executed in real time. A time limit to complete execution is set for the processing. The arithmetic unit is, for example, a server equipped with a GPU.

In the past, when executing an inference process for processing a moving image on a server equipped with a GPU, a management server has determined which inference process is to be arranged and executed on which server. Here, in a system with a relatively small number of servers and limited computing resources, it is desired to determine which inference process is favorably arranged and executed on which server, and determine which inference process is to be arranged and executed on which server.

However, in the past, it has been difficult to execute a plurality of inference processes efficiently using a plurality of servers. For example, since it is not possible to appropriately determine which inference process is favorably arranged and executed on which server, it is not possible to execute a plurality of inference processes efficiently using a plurality of servers. Specifically, there are cases where a plurality of inference processes is arranged in a plurality of servers without considering whether the execution of each inference process can be completed within the time limit set for the inference process.

For example, a method of arranging a plurality of inference processes on a server having a relatively large free computing resource in ascending order of remaining time to a set time limit is conceivable. In this method, it is not guaranteed that execution of any inference process arranged in any server can be completed within the set time limit, and it is difficult to appropriately execute the plurality of inference processes efficiently using a plurality of servers.

Furthermore, for example, a method of arranging, when an inference execution request of a plurality of inference processes is received in a certain period, the plurality of inference processes on a server having a relatively large free computing resource in the order of receiving the inference execution request is conceivable. In this method, it is not guaranteed that execution of any inference process arranged in any server can be completed within the set time limit, and it is difficult to appropriately execute the plurality of inference processes efficiently using a plurality of servers.

Furthermore, for example, a method of enabling distributed arrangement of any one of inference processes on two or more servers when arranging a plurality of inference processes on a plurality of servers is conceivable. With this method, it is difficult to efficiently use the servers. For example, there is a problem that, in a case where the inference process is arranged in a distributed manner, a model to be used for the inference process is read by each server of the two or more servers in which the inference process is arranged in a distributed manner, and the efficiency to use the servers is deteriorated.

Furthermore, for example, a method of verifying all of arrangement patterns of arranging a plurality of inference processes on a plurality of servers, and determining an appropriate arrangement pattern capable of completing execution of each of the inference processes by a set time limit and capable of efficiently using a server is conceivable. This method has a problem that the processing time and processing load needed to determine the appropriate arrangement pattern tend to be enormous.

Therefore, in the present embodiment, an information processing method capable of executing a plurality of pieces of processing efficiently using one or more arithmetic units while enabling completion of execution of each processing within a time limit set for the processing will be described.

In FIG. 1, there is an information processing device 100 and an arithmetic unit on which processing can be arranged. The arithmetic unit is, for example, a computer capable of executing processing. The arithmetic unit may be, for example, a core of a computer, which is capable of executing processing.

The arrangement is allocation. The arrangement includes, for example, determining on which arithmetic unit processing is to be executed. The arrangement includes, for example, determining on which arithmetic unit the processing is to be executed and when to start the processing. The arrangement includes, for example, determining on which execution process frame on which arithmetic unit the processing is to be executed. The substance of the execution process frame is, for example, some sort of processing process. The processing process operates as the arranged processing when, for example, a model to be used for the processing and information to be operated in the processing are designated.

In the example of FIG. 1, the arithmetic unit has two execution process frames and can execute two pieces of processing in parallel. Furthermore, there is a plurality of pieces of processing requested to be executed. The processing is to perform a predetermined operation for data, for example. The data is, for example, a frame. Required time indicating a time limit for completing execution of each processing is set.

In the example of FIG. 1, an inference process a of requestA and an inference process b of requestB are present. As illustrated in Table 120, the required time 0:20 [s] is set in the inference process a of requestA. The inference process a of requestA is processing of performing an operation for data for 10 [frames]. The required time 0:50 [s] is set in the inference process b of requestB. The inference process b of requestB is processing of performing an operation for data for 30 [frames].

(1-1) The information processing device 100 acquires profile information enabling specification of time needed to prepare for execution of each processing of a plurality of pieces of processing and time needed to execute the processing. The time needed to prepare for execution of the processing is, for example, time needed to initialize the GPU and read the model to be used to execute the processing.

In the example of FIG. 1, the information processing device 100 acquires, for the inference process a of requestA, the time needed 5 [s] for initialize and read the model to be used for the inference process a and the time needed 1 [s/frame] to execute the inference process a. Furthermore, the information processing device 100 acquires, for the inference process b of requestB, the time needed 5 [s] for initialize and read the model to be used for the inference process b and the time needed 1 [s/frame] to execute the inference process b.

(1-2) When arranging a plurality of pieces of processing for one or more arithmetic units, the information processing device 100 determines an arrangement pattern of the plurality of pieces of processing for one or more arithmetic units by referring to the profile information and searching for nodes from a root to a leaf in a tree structure 110. For example, the tree structure 110 is formed such that nodes representing positions where pieces of processing included in the plurality of pieces of processing are arranged are connected from a root to a lower level, and the deeper the hierarchy, the more pieces of processing are arranged.

The information processing device 100 determines an arrangement pattern of the plurality of pieces of processing for one or more arithmetic units, which maximizes the execution efficiency for the plurality of pieces of processing, by referring to the profile information and performing a search such that execution of each processing is completed within a time limit, for example. The execution efficiency is calculated from, for example, a ratio of a total amount of the arranged pieces of processing to a total occupied time of the arranged pieces of processing. The amount of processing is, for example, the amount of data handled in the processing. The occupied time is a time during which the arithmetic unit is used in the preparation and execution of the processing. Specifically, the execution efficiency can be calculated by the equation (1) to be described below.

(1-2-1) In the example of FIG. 1, the information processing device 100 generates root 0 of the tree structure 110. The information processing device 100 generates node 1 indicating a result of arranging the inference process a in execution process frame #1 of the arithmetic unit, and connects the node 1 to a lower level of the root 0. The result of arrangement is denoted by reference numeral 111, for example. (#1 and #2) in the figure indicate how much data is handled in each of the execution process frame #1 and the execution process frame #2. The information processing device 100 calculates the time needed 0.15 [s] until the execution of the arranged inference process a is completed, determines whether the calculated time needed 0.15 [s] satisfies the required time 0:20 [s], and calculates the execution efficiency 0.67 [fps] at the node 1.

The time needed may include, for example, a waiting time from the current moment to the start of execution of the inference process. For example, the time needed satisfying the required time means that the time needed does not exceed the required time. The time needed not satisfying the required time means that the time needed exceeds the required time. The time needed exceeding the required time means that the time needed exceeds the time from the current time to the required time. The time needed not exceeding the required time means that the time needed is less than the time from the current time to the required time.

Here, it is assumed that the information processing device 100 determines that the calculated time needed 0.15 [s] satisfies the required time 0:20 [s] because the time needed does not exceed the required time 0:20 [s]. In the case where the information processing device 100 determines that the time needed satisfies the required time 0:20 [s], the information processing device 100 moves onto the operation of (1-2-2). Meanwhile, in the case where the information processing device 100 determines that the time needed does not satisfy the required time 0:20 [s], the information processing device 100 may delete the node 1 without moving onto the operation of (1-2-2).

(1-2-2) The information processing device 100 generates node 2 indicating a result of arranging the inference process b in execution process frame #2 of the arithmetic unit, and connects the node 2 to a lower level of the node 1 in the case of determining that the required time 0:20 [s] is satisfied. The result of arrangement is denoted by reference numeral 112, for example. The information processing device 100 calculates the time needed 0.35 [s] until the execution of the arranged inference process b is completed, determines whether the calculated time needed satisfies the required time 0:50 [s], and calculates the execution efficiency 0.8 [fps] at the node 2.

Here, it is assumed that the information processing device 100 determines that the calculated time needed 0.35 [s] satisfies the required time 0:50 [s] because the time needed does not exceed the required time 0:50 [s]. In the case where the information processing device 100 determines that the time needed satisfies the required time 0:50 [s], the information processing device 100 moves onto the operation of (1-2-3). Meanwhile, in the case where the information processing device 100 determines that the time needed does not satisfy the required time 0:50 [s], the information processing device 100 may delete the node 2 and move onto the operation of (1-2-3).

(1-2-3) Since the required time 0:50 [s] is satisfied and the node 2 is a leaf, the information processing device 100 generates node 3 indicating a result of rearranging the inference process b, and connects the node 3 to a lower level of the node 1. The information processing device 100 determines whether the time needed until the execution of the arranged inference process b of requestB is completed satisfies the required time 0:50 [s], and calculates the execution efficiency at the node 3, similarly to the node 2.

Here, it is assumed that the information processing device 100 determines that the calculated time needed satisfies the required time 0:50 [s] because the time needed does not exceed the required time 0:50 [s]. In the case where the information processing device 100 determines that the time needed satisfies the required time 0:50 [s], the information processing device 100 moves onto the operation of (1-2-4). Meanwhile, in the case where the information processing device 100 determines that the time needed does not satisfy the required time 0:50 [s], the information processing device 100 may delete the node 3 and move onto the operation of (1-2-4).

(1-2-4) The information processing device 100 generates node 4 indicating a result of rearranging the inference process a, and connects the node 4 to a lower level of the node 0. The result of arrangement is denoted by reference numeral 113, for example. The information processing device 100 determines whether the time needed until the execution of the arranged inference process a of requestA is completed satisfies the required time 0:20 [s], and calculates the execution efficiency at the node 4, similarly to the node 1.

Here, it is assumed that the information processing device 100 determines that the calculated time needed 0.10 [s] satisfies the required time 0:20 [s] because the time needed does not exceed the required time 0:20 [s]. In the case where the information processing device 100 determines that the time needed satisfies the required time 0:20 [s], the information processing device 100 moves onto the operation of (1-2-5). Meanwhile, in the case where the information processing device 100 determines that the time needed does not satisfy the required time 0:20 [s], the information processing device 100 may delete the node 4 without moving onto the operation of (1-2-5).

(1-2-5) Since the required time 0:20 [s] is satisfied, the information processing device 100 generates node 5 indicating a result of rearranging the inference process b, and connects the node 5 to a lower level of the node 4. The information processing device 100 determines whether the time needed until the execution of the arranged inference process b is completed satisfies the required time 0:50 [s], and calculates the execution efficiency at the node 5. After that, the information processing device 100 similarly generates nodes 6 and 7 and the like, and calculates the execution efficiency.

(1-2-6) The information processing device 100 specifies a leaf having the maximum calculated execution efficiency among leaves remaining in the tree structure 110. The information processing device 100 determines an arrangement pattern for arranging a plurality of inference processes for one or more arithmetic units, which is indicated by a route from the root to the specified leaf, as an appropriate arrangement pattern capable of maximizing the execution efficiency for the plurality of inference processes.

As a result, the information processing device 100 can determine the appropriate arrangement pattern. The information processing device 100 can determine the appropriate arrangement pattern for enabling execution of a plurality of pieces of processing efficiently using one or more arithmetic units while enabling completion of the execution of each processing within a time limit set for the processing, for example.

The information processing device 100 can maximize the execution efficiency of the plurality of pieces of processing and can efficiently use the arithmetic units even if any of the pieces of processing can be arranged in two or more servers in a distributed manner. The information processing device 100 can determine the appropriate arrangement pattern without verifying all the arrangement patterns for arranging the plurality of pieces of processing for a plurality of servers and can reduce the processing time and processing load on determining the appropriate arrangement pattern.

Here, the case where the information processing device 100 determines the appropriate arrangement pattern by searching the tree structure 110 while generating the tree structure 110 has been described, but the present embodiment is not limited to the case. For example, the information processing device 100 may determine the appropriate arrangement pattern by searching the tree structure 110 after generating the tree structure 110. Furthermore, the information processing device 100 may acquire the tree structure 110 from another computer that generates the tree structure 110. In this case, the information processing device 100 determines the appropriate arrangement pattern by searching the acquired tree structure 110.

Here, the case where the data is a frame of a moving image has been described, but the present embodiment is not limited to the case. For example, the data may be operation information about a computer, observation information about a natural phenomenon, biological information about a human body, or the like.

### Example of Information Processing System 200

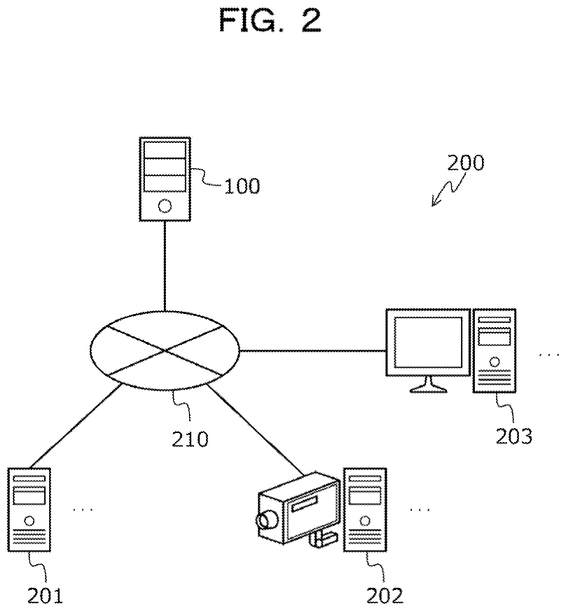

Next, an example of an information processing system 200 to which the information processing device 100 illustrated in FIG. 1 is applied will be described with reference to FIG. 2.

FIG. 2 is an explanatory diagram illustrating an example of the information processing system 200. In FIG. 2, the information processing system 200 includes the information processing device 100, one or more execution devices 201, one or more information collection devices 202, and one or more client devices 203.

In the information processing system 200, the information processing device 100 and the execution device 201 are connected via a wired or wireless network 210. The network 210 is, for example, a local area network (LAN), a wide area network (WAN), the Internet, or the like.

Furthermore, in the information processing system 200, the execution device 201 and the information collection device 202 are connected via the wired or wireless network 210. Furthermore, in the information processing system 200, the information processing device 100 and the client devices 203 are connected via the wired or wireless network 210.

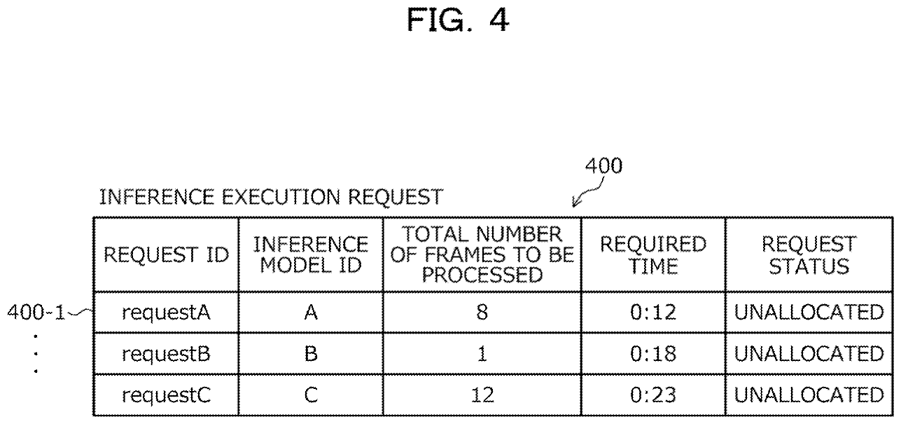

The information processing device 100 stores various tables described later in FIGS. 4 to 8. The information processing device 100 receives an inference execution request requesting execution of an inference process from the client device 203. The execution of an inference process is desired to be completed by a set time limit. In other words, the inference process is desired to perform a predetermined operation for information to be processed by the set time limit. The time limit is represented by, for example, the required time. The time limit is, for example, the required time several tens of seconds to several minutes ahead. The information processing device 100 stores the received inference execution request, using an inference execution request management table 400 to be described below in FIG. 4.

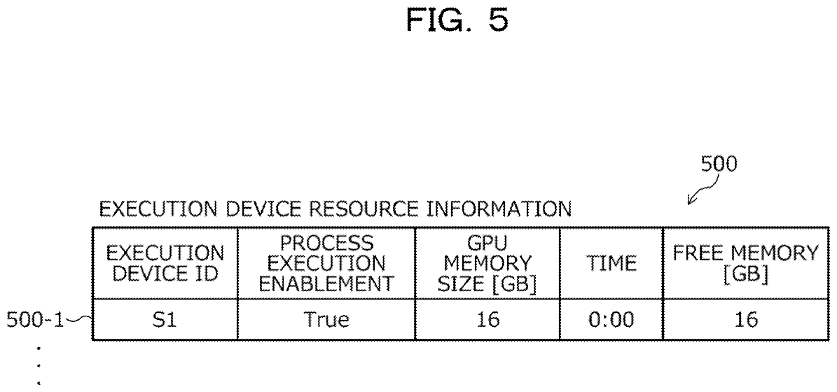

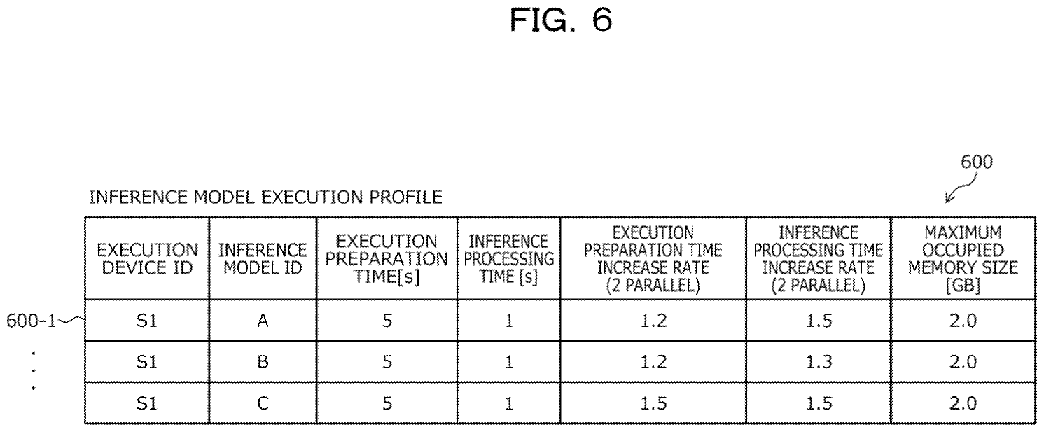

The information processing device 100 receives performance information of the execution device 201 from the execution device 201. The information processing device 100 stores the received performance information of the execution device 201, using an execution device resource information management table 500 to be described below in FIG. 5. The information processing device 100 receives, from the execution device 201, the profile information enabling specification of the time needed to prepare for execution of the inference process and the time needed to execute the inference process in the execution device 201. The information processing device 100 stores the received profile information, using an inference model execution profile management table 600 to be described below in FIG. 6.

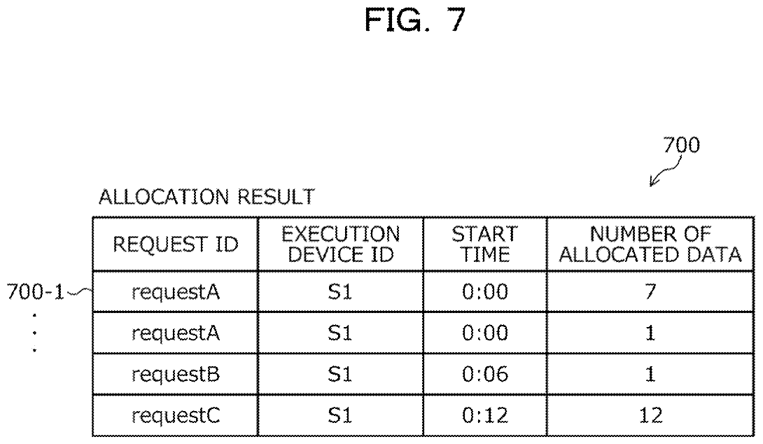

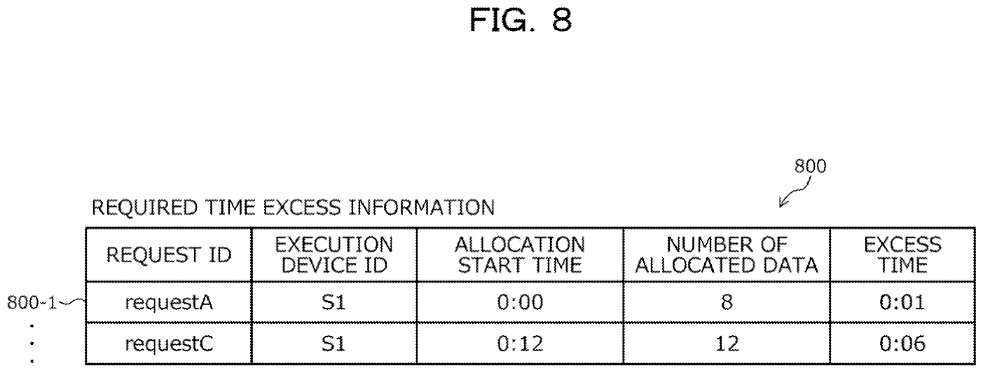

The information processing device 100 determines an appropriate arrangement pattern for arranging a plurality of inference processes for a plurality of execution devices 201 on the basis of the received profile information. The information processing device 100 determines an appropriate arrangement pattern by which execution of each inference process is completed by the required time and the execution device 201 is efficiently used, using a required time excess information management table 800 to be described below in FIG. 8, on the basis of the profile information, for example. The information processing device 100 stores the determined arrangement pattern, using an allocation result management table 700 to be described below in FIG. 7. The information processing device 100 arranges the plurality of inference processes for the plurality of execution devices 201 according to the determined arrangement pattern. The information processing device 100 is, for example, a server or a personal computer (PC), or the like.

The execution device 201 is a computer that has a GPU and executes an inference process. The execution device 201 generates the profile information enabling specification of the time needed to prepare for execution of the inference process and the time needed to execute the inference process and transmits the profile information to the information processing device 100. The execution device 201 executes the inference process allocated to its own node under the control of the information processing device 100. For example, the execution device 201 receives information to be handled in the inference process allocated to its own node from the information collection device 202, and executes the inference process allocated to its own node. The execution device 201 can execute a plurality of inference processes in parallel. The execution device 201 may transmit a result of executing the inference process to the client device 203. The execution device 201 is, for example, a server or a PC, or the like.

The information collection device 202 is a computer that collects information handled in the inference process. The information handled in the inference process is, for example, a frame of a moving image. The information collection device 202 transmits the collected information to the execution device 201. The information collection device 202 captures, for example, a moving image and transmits the moving image to the execution device 201. The collected information is required to undergo a predetermined operation by the time limit by, for example, an inference process. The time limit is represented by, for example, the required time. The time limit is, for example, the required time several tens of seconds to several minutes ahead. The information collection device 202 is, for example, a server, a personal computer (PC), a tablet terminal, a smartphone, a wearable terminal, a fixed point camera, or the like.

The client device 203 transmits an inference execution instruction to the information processing device 100 on the basis of a user's operation input. The user is, for example, an administrator of one or more execution devices 201 as a whole. The client device 203 may receive the result of executing the inference process from the execution device 201. The client device 203 outputs the result of executing the inference process in a referable manner to the user. Examples of the client device 203 include a server, a PC, a tablet terminal, or a smartphone, or the like.

### Specific Example of Information Processing System 200

Specifically, the information processing system 200 implements an object detection system in which the execution device 201 executes an inference process for detecting an object reflected in each frame of a moving image collected at each fixed time. Since the inference process is executed by the execution device 201 at each fixed time, it is desired to complete the execution of the inference process within the fixed time, and the time limit is set. The information processing device 100 determines the appropriate arrangement pattern for arranging the plurality of inference processes for the plurality of execution devices 201 so as to efficiently use the GPUs of the execution devices 201 in executing the inference processes. As a result, the information processing device 100 can efficiently use the GPU, which has a higher introduction cost than the CPU.

### Hardware Configuration Example of Information Processing Device 100

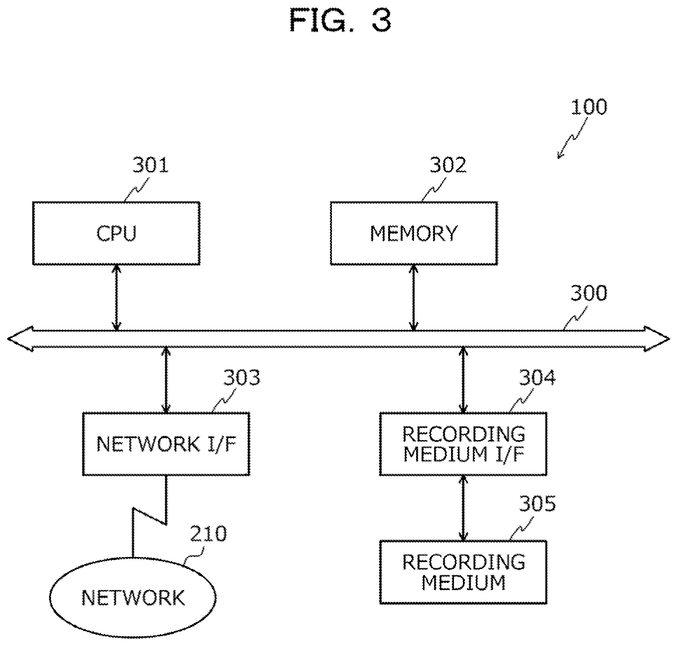

Next, a hardware configuration example of the information processing device 100 will be described with reference to FIG. 3.

FIG. 3 is a block diagram illustrating the hardware configuration example of the information processing device 100. In FIG. 3, the information processing device 100 includes a central processing unit (CPU) 301, a memory 302, a network interface (I/F) 303, a recording medium I/F 304, and a recording medium 305. Furthermore, the individual components are connected to one another by a bus 300, respectively.

Here, the CPU 301 performs overall control of the information processing device 100. The memory 302 includes, for example, a read only memory (ROM), a random access memory (RAM), a flash ROM, and the like. Specifically, for example, the flash ROM or the ROM stores various programs, and the RAM is used as a work area for the CPU 301. The programs stored in the memory 302 are loaded into the CPU 301 to cause the CPU 301 to execute coded processing.

The network I/F 303 is connected to the network 210 through a communication line, and is connected to another computer through the network 210. Then, the network I/F 303 is in charge of an interface between the network 210 and the inside, and controls input and output of data to and from another computer. The network I/F 303 is, for example, a modem, a LAN adapter, and the like.

The recording medium I/F 304 controls reading and writing of data to and from the recording medium 305 under the control of the CPU 301. Examples of the recording medium I/F 304 include a disk drive, a solid state drive (SSD), a universal serial bus (USB) port, and the like. The recording medium 305 is a nonvolatile memory that stores data written under the control of the recording medium I/F 304. The recording medium 305 is, for example, a disk, a semiconductor memory, a USB memory, or the like. The recording medium 305 may be attachable to and detachable from the information processing device 100.

The information processing device 100 may include, for example, a keyboard, a mouse, a display, a printer, a scanner, a microphone, a speaker, or the like in addition to the components described above. Furthermore, the information processing device 100 may include a plurality of the recording medium I/Fs 304 and the recording media 305. Furthermore, the information processing device 100 may not include the recording medium I/F 304 and the recording medium 305.

### Content Stored in Inference Execution Request Management Table 400

Next, an example of content stored in the inference execution request management table 400 will be described with reference to FIG. 4. The inference execution request management table 400 is implemented by a storage region of the memory 302, the recording medium 305, or the like of the information processing device 100 illustrated in FIG. 3, for example.

FIG, 4 is an explanatory diagram illustrating an example of content stored in the inference execution request management table 400. As illustrated in FIG. 4, the inference execution request management table 400 has fields of a request ID, an inference model ID, a total number of frames to be processed, required time, and a request status. In the inference execution request management table 400, the inference execution request is stored as a record 400-a by setting information in each field for each inference execution request. The letter a represents any integer.

In the request ID field, a request ID that identifies the inference execution request that requests execution of an inference process is set. In the inference model ID field, an inference model ID that identifies the inference model to be used to execute the above-described inference process is set. In the total number of frames to be processed field, the total number of frames handled in the above-described inference process is set. In the required time field, required time indicating the time limit for completing the execution of the above-described inference process is set. In the request status field, flag information indicating whether the above-described inference process has not been arranged or has been arranged is set.

### Content Stored in Execution Device Resource Information Management Table 500

Next, an example of content stored in an execution device resource information management table 500 will be described with reference to FIG. 5. The execution device resource information management table 500 is implemented by, for example, a storage region of the memory 302 or the recording medium 305 of the information processing device 100 illustrated in FIG. 3, or the like.

FIG. 5 is an explanatory diagram illustrating an example of content stored in the execution device resource information management table 500. As illustrated in FIG. 5, the execution device resource information management table 500 has fields of an execution device ID, process execution enablement, a GPU memory size [GB], the time, and a free memory [GB]. In the execution device resource information management table 500, the execution device resource information is stored as a record 500-b by setting information in each field for each execution device 201. The letter b represents any integer.

In the execution device ID field, an execution device ID that identifies the execution device 201 is set. In the process execution enablement field, flag information indicating whether the inference process is in an executable state in the above-described execution device 201 is set. In the GPU memory size [GB] field, a memory size [GB] corresponding to the GPU of the above-described execution device 201 is set. GB is giga byte. In the time field, the time indicating what time the execution device resource information corresponds to is set. In the free memory [GB] field, a free memory size [GB] in the memory size [GB] corresponding to the GPU of the above-described execution device 201 at the above time is set.

### Content Stored in Inference Model Execution Profile Management Table 600

Next, an example of content stored in the inference model execution profile management table 600 will be described with reference to FIG. 6. The inference model execution profile management table 600 is implemented by, for example, the storage region of the memory 302 or the recording medium 305 of the information processing device 100 illustrated in FIG. 3, or the like.

FIG. 6 is an explanatory diagram illustrating an example of content stored in the inference model execution profile management table 600. As illustrated in FIG. 6, the inference model execution profile management table 600 has fields of an execution device ID, an inference model ID, an execution preparation time [s], and an inference processing time [s]. Furthermore, the inference model execution profile management table 600 has fields of an execution preparation time increase rate, an inference processing time increase rate, and a maximum exclusive memory size [GB]. In the inference model execution profile management table 600, the inference model execution profile information is stored as a record 600-c by setting information in each field for each inference model. The letter c denotes any integer.

In the execution device ID field, an execution device ID that identifies the execution device 201 is set. In the inference model ID field, an inference model ID that identifies the inference model to be used to execute the inference process is set. In the execution preparation time [s] field, an execution preparation time [s], which is the time needed to initialize and read the above-described inference model, is set in the above-described execution device 201. s is second. In the inference processing time [s] field, an inference processing time [s], which is the time needed to perform a predetermined operation for the information for one frame by the above-described inference process in the above-described execution device 201, is set.

In the execution preparation time increase rate field, an execution preparation time increase rate indicating how much the execution preparation time of each inference process increases when two inference processes are executed in parallel in the above-described execution device 201 is set. In the inference processing time increase rate field, an inference processing time increase rate indicating how much the inference processing time of each inference process increases when two inference processes are executed in parallel in the above-described execution device 201 is set. In the maximum exclusive memory size [GB] field, a maximum exclusive memory size [GB] that is a maximum value of the memory size occupied by the above-described inference process is set.

### Contents Stored in Allocation Result Management Table 700

Next, an example of content stored in the allocation result management table 700 will be described with reference to FIG. 7. The allocation result management table 700 is implemented by a storage region of the memory 302, the recording medium 305, or the like of the information processing device 100 illustrated in FIG. 3, for example.

FIG. 7 is an explanatory diagram illustrating an example of content stored in the allocation result management table 700. As illustrated in. FIG. 7, the allocation result management table 700 has fields of a request ID, an execution device ID, start time, and the number of allocated data. In the allocation result management table 700, the allocation result is stored as a record 700-d by setting information in each field for each inference execution request. d is any integer.

In the request ID field, a request ID that identifies the inference execution request that requests execution of an inference process is set. In the execution device ID field, an execution device ID that identifies the above-described execution device 201 on which the inference process is arranged is set. In the start time field, start time at which the above-described execution device 201 starts execution of the above-described inference process is set. In the number of allocated data field, the number of data, which is the number of frames for performing a predetermined operation by the above-described inference process in the above-described execution device 201, is set.

### Content Stored in Required Time Excess Information Management Table 800

Next, an example of content stored in a required time excess information management table 800 will be described with reference to FIG. 8. The required time excess information management table 800 is implemented by, for example, a storage region of the memory 302 or the recording medium 305 of the information processing device 100 illustrated in FIG. 3, or the like.

FIG. 8 is an explanatory diagram illustrating an example of content stored in the required time excess information management table 800. As illustrated in FIG. 8, the required time excess information management table 800 has fields of a request ID, an execution device ID, allocation start time, the number of allocated data, and an excess time. In the required time excess information management table 800, the required time excess information is stored as a record 800-e by setting information in each field for each required time excess. e is any integer.

In the request ID field, a request ID that identifies the inference execution request that requests execution of an inference process is set. In the execution device ID field, an execution device ID that identifies the execution device 201 is set. In the allocation start time field, start time at which the above-described execution device 201 starts execution of the above-described inference process is set. In the number of allocated data field, the number of data, which is the number of frames for performing a predetermined operation by the above-described inference process in the above-described execution device 201, is set. In the excess time field, an excess time indicating how much the time to complete the execution of the inference process exceeds the required time corresponding to the above-described inference process when the above-described execution device 201 performs the predetermined operation for the number of above-described frames by the above-described inference process is set.

### Hardware Configuration Example of Execution Device 201

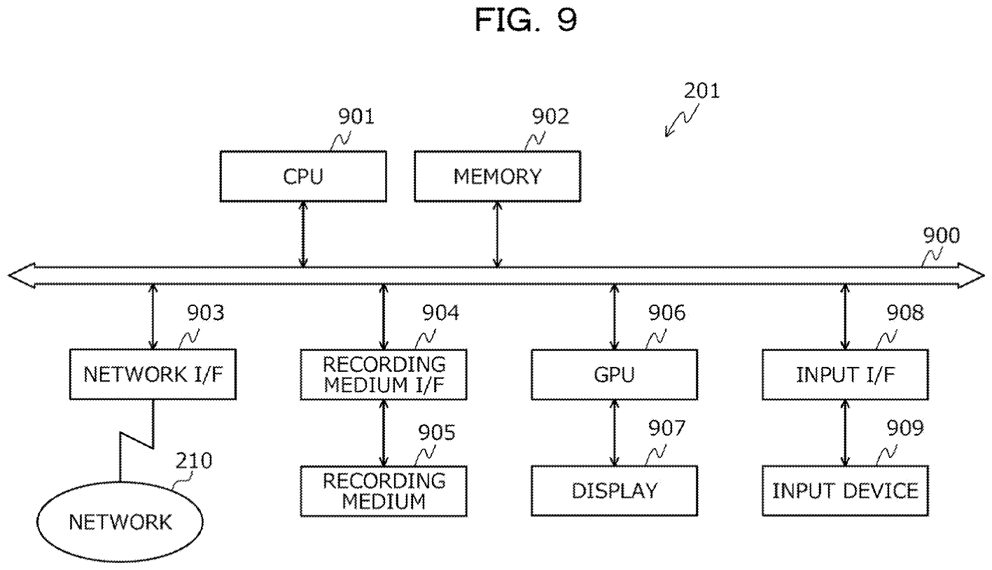

Next, a hardware configuration example of the execution device 201 will be described with reference to FIG. 9.

FIG. 9 is a block diagram illustrating a hardware configuration example of the execution device 201. In FIG. 9, the execution device 201 includes a CPU 901, a memory 902, a network I/F 903, a recording medium I/F 904, a recording medium 905, a GPU 906, a display 907, an input I/F 908, and an input device 909. Furthermore, the individual components are connected to one another by a bus 900, respectively.

Here, the CPU 901 performs overall control of the execution device 201. The memory 902 includes, for example, a ROM, a RAM, a flash ROM, and the like. Specifically, for example, the flash ROM or the ROM stores various programs, and the RAM is used as a work area for the CPU 901. The programs stored in the memory 902 are loaded into the CPU 901 to cause the CPU 901 to execute coded processing.

The network I/F 903 is connected to the network 210 through a communication line, and is connected to another computer through the network 210. Then, the network I/F 903 is in charge of an interface between the network 210 and the inside, and controls input and output of data to and from another computer. The network I/F 903 is, for example, a modem, a LAN adapter, and the like.

The recording medium I/F 904 controls reading and writing of data to and from the recording medium 905 under the control of the CPU 901. The recording medium I/F 904 is, for example, a disk drive, an SSD, a USB port, or the like. The recording medium 905 is a nonvolatile memory that stores data written under the control of the recording medium I/F 904. Examples of the recording medium 905 include a disk, a semiconductor memory, a USB memory, and the like. The recording medium 905 may be attachable to and detachable from the execution device 201.

The GPU 906 is a processing device that performs image processing. The display 907 displays data such as a document, an image, and function information, as well as a cursor, an icon, or a tool box. The display 907 is, for example, a cathode ray tube (CRT), a liquid crystal display, an organic electroluminescence (EL) display, or the like. The input I/F 908 is connected to the input device 909, controls the internal interface between the input device 909 and the inside, and controls input of data. The input device 909 has keys for inputting characters, numbers, various instructions, and the like, and inputs data. The input device 909 is, for example, a keyboard, a mouse, a touch panel-type input pad, a numeric keypad, or the like.

The execution device 201 may have, for example, a printer, a scanner, a microphone, a speaker, and the like, in addition to the above-described components. Furthermore, the execution device 201 may include a plurality of the recording medium I/Fs 904 and the recording media 905. Furthermore, the execution device 201 may not include the recording medium I/F 904 and the recording medium 905.

### Hardware Configuration Example of Information Collection Device 202

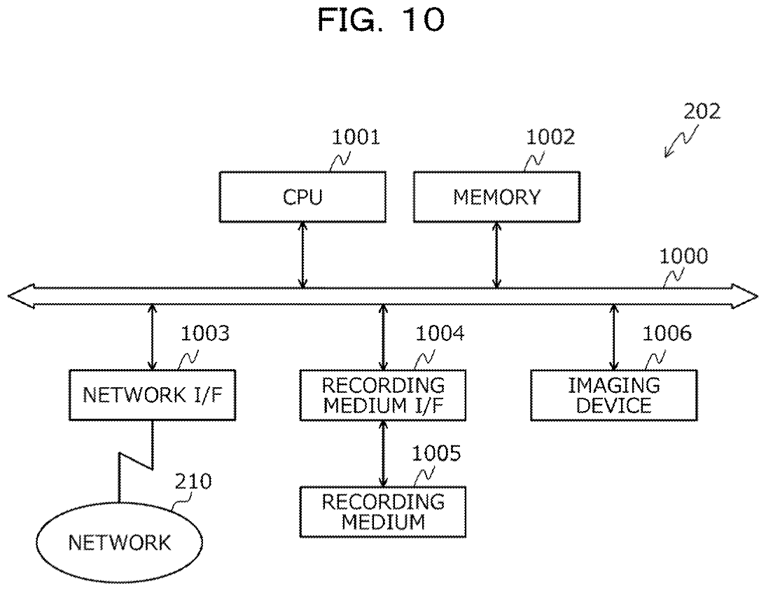

Next, a hardware configuration example of the information collection device 202 will be described with reference to FIG. 10.

FIG. 10 is a block diagram illustrating a hardware configuration example of the information collection device 202. In FIG. 10, the information collection device 202 includes a CPU 1001, a memory 1002, a network I/F 1003, a recording medium I/F 1004, a recording medium 1005, and an imaging device 1006. Furthermore, the individual components are connected by a bus 1000, respectively.

Here, the CPU 1001 performs overall control of the information collection device 202. The memory 1002 includes, for example, a ROM, a RAM, a flash ROM, and the like. Specifically, for example, the flash ROM or the ROM stores various programs, and the RAM is used as a work area for the CPU 1001. The programs stored in the memory 1002 are loaded into the CPU 1001 to cause the CPU 1001 to execute coded processing.

The network I/F 1003 is connected to the network 210 through a communication line, and is connected to another computer through the network 210. Then, the network I/F 1003 is in charge of an interface between the network 210 and the inside, and controls input and output of data to and from another computer. The network I/F 1003 is, for example, a modem, a LAN adapter, and the like.

The recording medium I/F 1004 controls reading and writing of data to and from the recording medium 1005 under the control of the CPU 1001. The recording medium I/F 1004 is, for example, a disk drive, an SSD, a USB port, or the like. The recording medium 1005 is a nonvolatile memory that stores data written under the control of the recording medium I/F 1004. Examples of the recording medium 1005 include a disk, a semiconductor memory, a USB memory, and the like. The recording medium 1005 may be attachable to and detachable from the information collection device 202. The imaging device 1006 is a device that captures a moving image formed by a plurality of frames. The imaging device 1006 is, for example, a camera.

The information collection device 202 may include, for example, a keyboard, a mouse, a display, a printer, a scanner, a microphone, a speaker, or the like in addition to the components described above. Furthermore, the information collection device 202 may include a plurality of the recording medium I/Fs 1004 and the recording media 1005. Furthermore, the information collection device 202 may not include the recording medium I/F 1004 and the recording medium 1005.

### Hardware Configuration Example of Client Device 203

Since the hardware configuration example of the client device 203 is specifically similar to the hardware configuration example of the execution device 201 illustrated in FIG. 9, for example, description thereof is omitted. The client device 203 may not include a GPU.

### Functional Configuration Example of Information Processing System 200

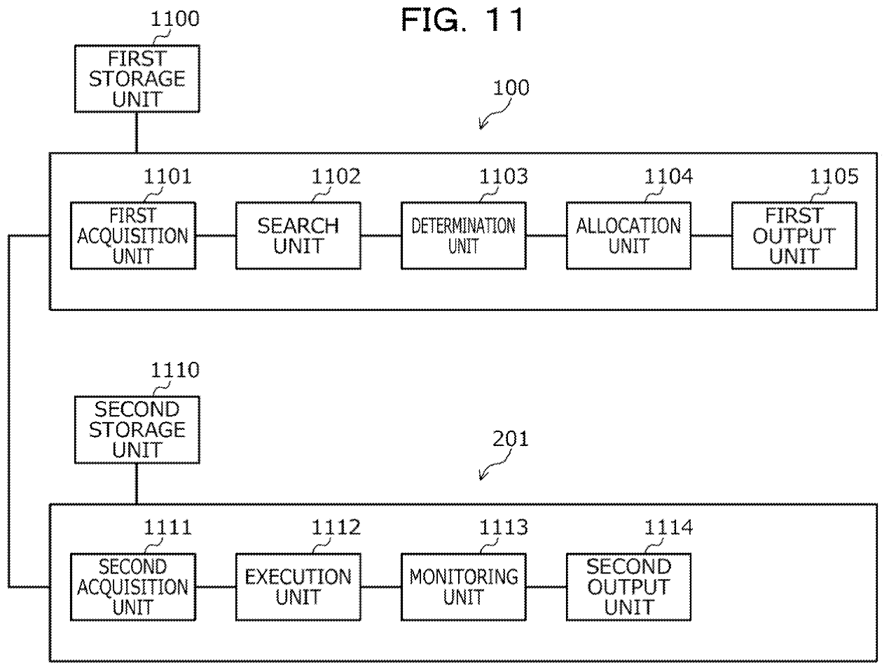

Next, a functional configuration example of the information processing system 200 will be described with reference to FIG. 11.

FIG. 11 is a block diagram illustrating a functional configuration example of the information processing system 200. In the information processing system 200, the information processing device 100 includes a first storage unit 1100, a first acquisition unit 1101, a search unit 1102, a determination unit 1103, an arrangement unit 1104, and a first output unit 1105.

The first storage unit 1100 is implemented by a storage region of the memory 302, the recording medium 305, or the like illustrated in FIG. 3, for example. Hereinafter, a case where the first storage unit 1100 is included in the information processing device 100 will be described. However, the embodiment is not limited to the case. For example, the first storage unit 1100 may be included in a device different from the information processing device 100, and content stored in the first storage unit 1100 may be able to be referred to by the information processing device 100.

The first acquisition unit 1101 to the first output unit 1105 function as an example of a control unit. Specifically, for example, the first acquisition unit 1101 to the first output unit 1105 implement functions thereof by causing the CPU 301 to execute a program stored in the storage region of the memory 302, the recording medium 305, or the like or by the network I/F 303 illustrated in FIG. 3. A processing result of each functional unit is stored in the storage region of the memory 302, the recording medium 305, or the like illustrated in FIG. 3, for example.

The first storage unit 1100 stores various types of information to be referred to or updated in the processing of each functional unit. The first storage unit 1100 stores a request to execute processing. The processing is, for example, an inference process. The processing is performed using, for example, a model. The request is, for example, an inference execution request. The first storage unit 1100 stores the inference execution request, using the inference execution request management table 400 illustrated in FIG. 4, for example.

The first storage unit 1100 stores the profile information enabling specification of the time needed to prepare for execution of processing and the time needed to execute the processing in the arithmetic unit. The arithmetic unit is, for example, the execution device 201. The arithmetic unit may be, for example, the core of the execution device 201. The preparation for execution is, for example, initialization and reading of the model to be used for execution of the processing. The first storage unit 1100 stores the profile information, using the inference model execution profile management table 600 illustrated in FIG. 6, for example.

The first storage unit 1100 stores a result of arranging a plurality of pieces of processing for one or more arithmetic units. The arrangement is allocation. The arrangement includes, for example, determining on which arithmetic unit processing is to be executed. Thee arrangement includes, for example, determining on which arithmetic unit the processing is to be executed and when to start the processing. The arrangement includes, for example, determining on which execution process frame on which arithmetic unit the processing is to be executed. The substance of the execution process frame is, for example, some sort of processing process. The processing process can implement the arranged predetermined processing. The processing process implements the predetermined processing when the model to be used for the predetermined processing and information to be operated in the predetermined processing are designated, for example. The first storage unit 1100 stores, for example, the appropriate arrangement pattern for arranging a plurality of pieces of processing for one or more arithmetic units, using the allocation result management table 700 illustrated in FIG. 7.

The first storage unit 1100 stores a tree structure. For example, the tree structure is formed such that nodes representing positions where pieces of processing included in the plurality of pieces of processing are arranged are connected from a root to a lower level, and the deeper the hierarchy, the more pieces of processing are arranged. For example, the tree structure is formed such that information indicating positions where pieces of processing are arranged are hierarchized as nodes, and the deeper the hierarchy, the more pieces of processing are arranged. The tree structure is generated by, for example, the search unit 1102.

The first acquisition unit 1101 acquires various types of information to be used for the processing of each functional unit. The first acquisition unit 1101 stores the acquired various types of information in the first storage unit 1100 or outputs the acquired various types of information to each functional unit. Furthermore, the first acquisition unit 1101 may output the various types of information stored in the first storage unit 1100 to each functional unit. The first acquisition unit 1101 acquires various types of information, for example, on the basis of an operation input of the user of the information processing device 100. The first acquisition unit 1101 may receive various types of information from a device different from the information processing device 100, for example.

The first acquisition unit 1101 acquires a request to execute each processing of a plurality of pieces of processing executed using different models. The first acquisition unit 1101 acquires, by receiving, the inference execution request requesting execution of an inference process from the client device 203. As a result, the first acquisition unit 1101 can specify the plurality of pieces of processing to be arranged for one or more arithmetic units.

The first acquisition unit 1101 acquires the profile information enabling specification of the time needed to prepare for execution of each processing of a plurality of pieces of processing executed using different models and the time needed to execute the processing. The first acquisition unit 1101 acquires, by receiving, the profile information from the execution device 201. As a result, the first acquisition unit 1101 can evaluate whether the execution of the processing can be completed by the time limit set for the processing. Furthermore, the first acquisition unit 1101 can obtain information that serves as a guideline for evaluating the efficiency of using the arithmetic unit.

The first acquisition unit 1101 may accept a start trigger to start processing of any one of the functional units. The start trigger is, for example, a predetermined operation input by the user of the information processing device 100. The start trigger may be, for example, receipt of predetermined information from another computer. The start trigger may be, for example, output of predetermined information by any one of the functional units.

The search unit 1102 searches for the nodes from the root to the leaf such that the execution of each processing can be completed within the time limit set for the processing in the tree structure by referring to the acquired profile information. The search unit 1102 searches for the nodes from the root to the leaf while generating the tree structure. The search unit 1102 searches for the nodes from the root to the leaf after generating the tree structure.

The search unit 1102 refers to the acquired profile information, and traces the node at which the execution of each processing arranged in one or more arithmetic units among a plurality of pieces of processing can be completed within the time limit set for the processing from the root in the tree structure and specifies a reachable leaf, for example. Then, the search unit 1102 calculates the execution efficiency for the plurality of pieces of processing in, for example, each of the identified reachable leaves, on the basis of a cumulative time needed for preparation for execution and execution of the each processing.

Specifically, the search unit 1102 generates a root and sets the root as a target node. Thereafter, specifically, the search unit 1102 generates the tree structure by repeating an operation of connecting a new node representing the position where any one piece of processing of the plurality of pieces of processing is arranged to the lower level of a certain node set as the target node, and setting the new node as the target node.

More specifically, the search unit 1102 repeats an operation of connecting a new node representing the position where any one piece of processing to which a relatively short time limit is set among unarranged pieces of processing to the lower level of the certain node, and setting the new node as the target node. As a result, the search unit 1102 can preferentially make the processing having a relatively short time limit executable and can search for nodes from the root to the leaf while generating the tree structure such that the time to complete the execution of the processing unlikely exceeds the time limit.

More specifically, the search unit 1102 determines, when repeating the operation, whether the execution of certain processing arranged at the position represented by a certain node set as the target node can be completed within the time limit set for the certain processing. Furthermore, more specifically, the search unit 1102 determines whether the certain node set as the target node is a leaf.

Here, more specifically, in the case where the execution of the certain processing is not able to be completed, the search unit 1102 connects a new node representing a position different from the position represented by the certain node, where the certain processing having been arranged at the position represented by the certain node is newly arranged, to the lower level of the parent of the certain node. Then, more specifically, the search unit 1102 deletes the certain node set as the target node, and sets the new connected node as the target node.

More specifically, in the case where the execution of the certain processing is not able to be completed, the search unit 1102 connects a new node representing a position where the certain processing is newly arranged in a distributed manner such that the execution of the certain processing can be completed within the time limit set for the certain processing to the lower level of the parent of the certain node. Then, more specifically, the search unit 1102 deletes the certain node set as the target node, and sets the new connected node as the target node. Thereby, the search unit 1102 can search for the nodes from the root to the leaf while generating the tree structure such that the time to complete the execution of the processing to be arranged does not exceed the time limit set for the processing.

Meanwhile, more specifically, in the case where the execution of the certain processing can be completed and the certain node set as the target node is not a leaf, the search unit 1102 connects a new node representing a position where processing different from the processing arranged at the position represented by the certain node is arranged to the lower level of the certain node. Then, more specifically, the search unit 1102 sets the connected new node as the target node. As a result, the search unit 1102 can arrange the processing in order and can generate the tree structure.

Furthermore, more specifically, in the case where the execution of the certain processing can be completed and the certain node set as the target node is a leaf, the search unit 1102 calculates the execution efficiency for the plurality of pieces of processing at the certain node. The execution efficiency is calculated from, for example, a ratio of a total amount of the arranged pieces of processing to a total occupied time of the arranged pieces of processing. The amount of processing is, for example, the amount of data handled in the processing. The occupied time is a time during which the arithmetic unit is used in the preparation and execution of the processing. As a result, the search unit 1102 can obtain information that serves as a guideline for determining the arrangement pattern of the plurality of pieces of processing,

The determination unit 1103 determines an arrangement pattern of the plurality of pieces of processing for one or more arithmetic units, which can maximize the execution efficiency for the plurality of pieces of processing, on the basis of the search result. The determination unit 1103 determines the arrangement pattern of the plurality of pieces of processing on the basis of the leaf having the maximum calculated execution efficiency among reachable leaves, for example. Specifically, the determination unit 1103 determines an arrangement pattern indicated by a route from the root to the leaf having the maximum calculated execution efficiency as the arrangement pattern of the plurality of pieces of processing. As a result, the determination unit 1103 can determine the appropriate arrangement pattern.

The arrangement unit 1104 arranges the plurality of pieces of processing for one or more arithmetic units according to the determined arrangement pattern. The arrangement unit 1104 transmits, for example, a request to execute the processing arranged in each arithmetic unit of the one or more arithmetic units to the each arithmetic unit according to the determined arrangement pattern. The request includes, for example, information that enables specification of the processing to be arranged. The request includes, for example, information that enables specification of the model to be used to execute the processing to be arranged. As a result, the arrangement unit 1104 can execute the plurality of pieces of processing efficiently using one or more arithmetic units.

The first output unit 1105 outputs a processing result of at least any one of the functional units. An output format is, for example, display on a display, print output to a printer, transmission to an external device by the network I/F 303, or storage in the storage region such as the memory 302 or the recording medium 305. As a result, the first output unit 1105 can notify the user of the information processing device 100 of a processing result of at least any one of the functional units and can improve convenience of the information processing device 100. The first output unit 1105 outputs, for example, the determined arrangement pattern.

Furthermore, in the information processing system 200, the execution device 201 includes a second storage unit 1110, a second acquisition unit 1111, an execution unit 1112, a monitoring unit 1113, and a second output unit 1114.

The second storage unit 1110 is implemented by a storage region of the memory 902, the recording medium 905, or the like illustrated in FIG. 9, for example. Hereinafter, a case in which the second storage unit 1110 is included in the execution device 201 will be described but the embodiment is not limited to the case. For example, the second storage unit 1110 may be included in a device different from the information processing device 100, and content stored in the second storage unit 1110 may be able to be referred to by the execution device 201.

The second acquisition unit 1111 to the second output unit 1114 function as an example of a control unit. Specifically, for example, the second acquisition unit 1111 to the second output unit 1114 implement functions thereof by causing the CPU 901 to execute a program stored in the storage region of the memory 902, the recording medium 905, or the like or by the network I/F 903 illustrated in FIG. 9. A processing result of each functional unit is stored in the storage region of the memory 902, the recording medium 905, or the like illustrated in FIG. 9, for example.

The second storage unit 1110 stores various types of information to be referred to or updated in the processing of each functional unit. The second storage unit 1110 stores the model to be used to execute the processing. The second storage unit 1110 stores the profile information enabling specification of the time needed to prepare for execution of processing arranged in the execution device and the time needed to execute the processing arranged in the execution device. The second storage unit 1110 stores the information to be processed. The second storage unit 1110 stores, for example, each frame of the moving image that is the target for the inference process.

The second acquisition unit 1111 acquires various types of information to be used for the processing of each functional unit. The second acquisition unit 1111 stores the acquired various types of information in the second storage unit 1110 or outputs the acquired various types of information to each functional unit. Furthermore, the second acquisition unit 1111 may output the various types of information stored in the second storage unit 1110 to each functional unit. The second acquisition unit 1111 acquires various types of information on the basis of an operation input of the user of the execution device 201, for example. The second acquisition unit 1111 may receive various types of information from a device different from the information processing device 100, for example.

The second acquisition unit 1111 acquires a request to execute the processing arranged in the execution device, which enables specification of the processing arranged in the execution device. The second acquisition unit 1111 acquires the request to execute the processing arranged in the execution device by receiving the request from the information processing device 100. The second acquisition unit 1111 may acquire the request to execute the processing arranged in the execution device by receiving an input of the request on the basis of the user's operation input of the execution device 201. The second acquisition unit 1111 may acquires the request to execute the processing arranged in the execution device by receiving the request from the client device 203.

The second acquisition unit 1111 may accept a start trigger to start processing of any one of the functional units. The start trigger is, for example, a predetermined operation input by the user of the execution device 201. The start trigger may be, for example, receipt of predetermined information from another computer. The start trigger may be, for example, output of predetermined information by any one of the functional units. The second acquisition unit 1111 receives the acquisition of the request as a start trigger for starting the processing of the execution unit 1112 or the monitoring unit 1113, for example.

The execution unit 1112 executes the processing arranged in the execution device. The execution unit 1112 executes the processing on the basis of the information to be processed, using, for example, the model corresponding to the arranged processing. Specifically, the execution unit 1112 acquires the model corresponding to the arranged inference process and each frame of the moving image that is the target for the inference process. Then, specifically, the execution unit 1112 executes the inference process by performing a predetermined operation for each frame of the acquired moving image according to the acquired model. As a result, the execution unit 1112 can execute the processing arranged in the execution device.

The monitoring unit 1113 monitors the execution status of the processing arranged in the execution device and generates the profile information enabling specification of the time needed to prepare for execution of processing and the time needed to execute the processing. As a result, the monitoring unit 1113 can provide the profile information to the information processing device 100 without the user of the execution device 201 creating the profile information.

The second output unit 1114 outputs the processing result of each functional unit. An output format is, for example, display on a display, print output to a printer, transmission to an external device by the network I/F 903, or storage in the storage region such as the memory 902 or the recording medium 905. As a result, the second output unit 1114 can notify the user of the execution device 201 of the processing result of each functional unit.

The second output unit 1114 outputs, for example, the result of executing the processing arranged in the execution device. Specifically, the second output unit 1114 transmits the result of executing the inference process to the client device 203. As a result, the second output unit 1114 can make the result of executing the processing arranged in the execution device referable by an administrator.

The second output unit 1114 transmits the profile information enabling specification of the time needed to prepare for execution of processing and the time needed to execute the processing in the execution device to the information processing device 100, for example. As a result, the second output unit 1114 can make the profile information available to the information processing device 100.

### Specific Functional Configuration Example of Information Processing System 200

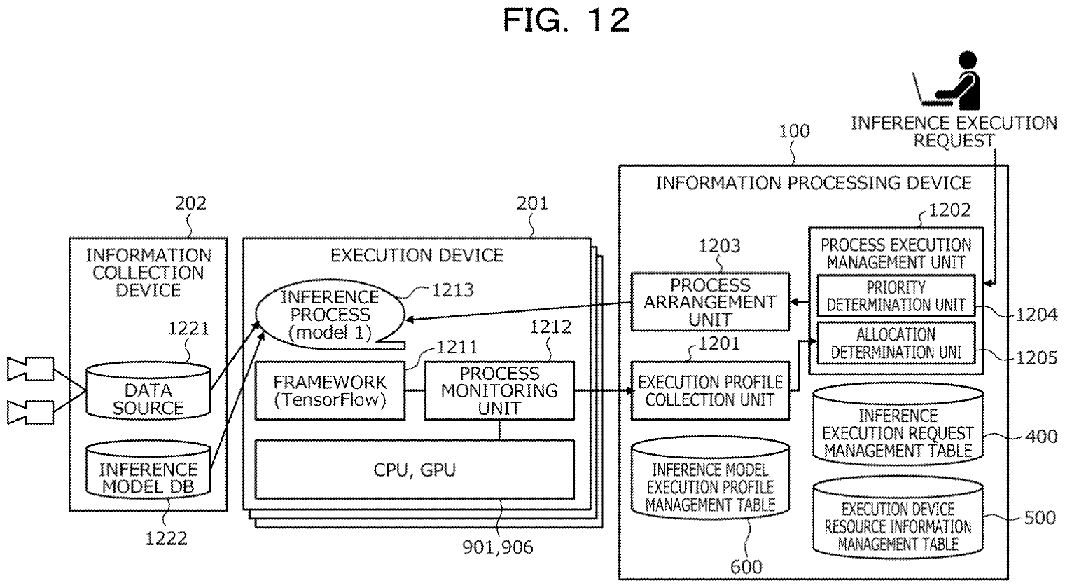

Next, a specific functional configuration example of the information processing system 200 will be described with reference to FIG. 12.

FIG. 12 is a block diagram illustrating a specific functional configuration example of the information processing system 200. In the information processing system 200, the information processing device 100 includes an execution profile collection unit 1201, a process execution management unit 1202, and a process arrangement unit 1203. The process execution management unit 1202 includes a priority determination unit 1204 and an arrangement determination unit 1205. The information processing device 100 stores the inference execution request management table 400, the execution device resource information management table 500, and the inference model execution profile management table 600.

Furthermore, the execution device 201 includes a framework 1211 and a process monitoring unit 1212. The execution device 201 is capable of executing an inference process 1213. The execution device 201 may be able to execute two or more inference processes 1213 in parallel. Furthermore, the information collection device 202 stores a data source 1221 and an inference model database (DB) 1222. The data source 1221 stores the frames calculated in the inference process. The inference model DB 1222 stores the inference model.

The execution profile collection unit 1201 acquires an inference model execution profile that enables specification of the time needed for initialization and reading the inference model and the time needed for execution when executing the inference process from the process monitoring unit 1212. The execution profile collection unit 1201 stores the acquired inference model execution profile, using the inference model execution profile management table 600.

The process execution management unit 1202 receives the inference execution request from the client device 203 and stores the inference execution request, using the inference execution request management table 400. The process execution management unit 1202 specifies an unarranged inference process among the inference processes indicated by the inference execution request as a processing target. The process execution management unit 1202 determines the priority for arranging each inference process specified as the processing target at each fixed time by referring to the inference execution request management table 400 by the priority determination unit 1204. The priority determination unit 1204 determines the priority of arranging each inference process specified as the processing target such that the inference process has higher priority in ascending order of the remaining time to the required time, for example.

The process execution management unit 1202 arranges, by the arrangement determination unit 1205, the inference process specified as the processing target in one or more execution devices 201. The arrangement includes, for example, determining on which execution device 201 the inference process is to be executed. The arrangement includes, for example, determining on which execution device 201 the inference process is to be executed and when to start the inference process. The arrangement includes, for example, determining on which execution process frames on which execution device 201 the inference processes are to be executed when the execution device 201 can execute two or more inference processes in parallel.

The arrangement determination unit 1205 refers to, for example, the execution device resource information management table 500 and the inference model execution profile management table 600, and arranges the inference process specified as the processing target to one or more execution devices 201 in descending order of priority. Specifically, the arrangement determination unit 1205 searches for the nodes from the root to the leaf such that the execution of each inference process is completed by the required time limit while generating the tree structure, and determines the appropriate arrangement pattern on the basis of the leaf having the highest execution efficiency.

The arrangement determination unit 1205 may exclude any one of the inference processes from the processing target and try determination of the appropriate arrangement pattern again in the case where there is no appropriate arrangement pattern by which the execution of each inference process can be completed by the required time limit, for example. Specifically, the arrangement determination unit 1205 excludes the inference process having the longest remaining time to the required time limit and the lowest priority from the processing target. The arrangement determination unit 1205 may notify the administrator of arrangement failure via the client device in the case where there is no appropriate arrangement pattern by which the execution of each inference process can be completed by the required time limit, for example.

The process arrangement unit 1203 arranges the inference process in the execution device 201 and executes the inference process according to the determined arrangement pattern. The process arrangement unit 1203 transmits a request to execute the inference process to the execution device 201 according to the determined arrangement pattern, for example. The request includes information that enables specification of the inference model to be used in the inference process. The request includes information that enables specification of the frame to be calculated in the inference process.

The framework 1211 executes the inference process arranged in the execution device. The framework 1211 receives, for example, the request to execute the inference process from the information processing device 100. The framework 1211 communicates with the information collection device 202 on the basis of the received request, for example, and obtains the inference model to be used in the inference process from the inference model DB 1222. The framework 1211 communicates with the information collection device 202 on the basis of the received request, for example, and obtains the frame to be calculated in the inference process from the data source 1221. The framework 1211 executes the inference process that calculates the acquired frame using the acquired inference model on the basis of the received request, for example.

The process monitoring unit 1212 monitors the framework 1211 and generates the inference model execution profile that enables specification of the time needed for initialization and reading the inference model and the time needed for execution when executing inference process 1213. The process monitoring unit 1212 transmits the generated inference model execution profile to the information processing device 100.

### Operation Example of Information Processing System 200

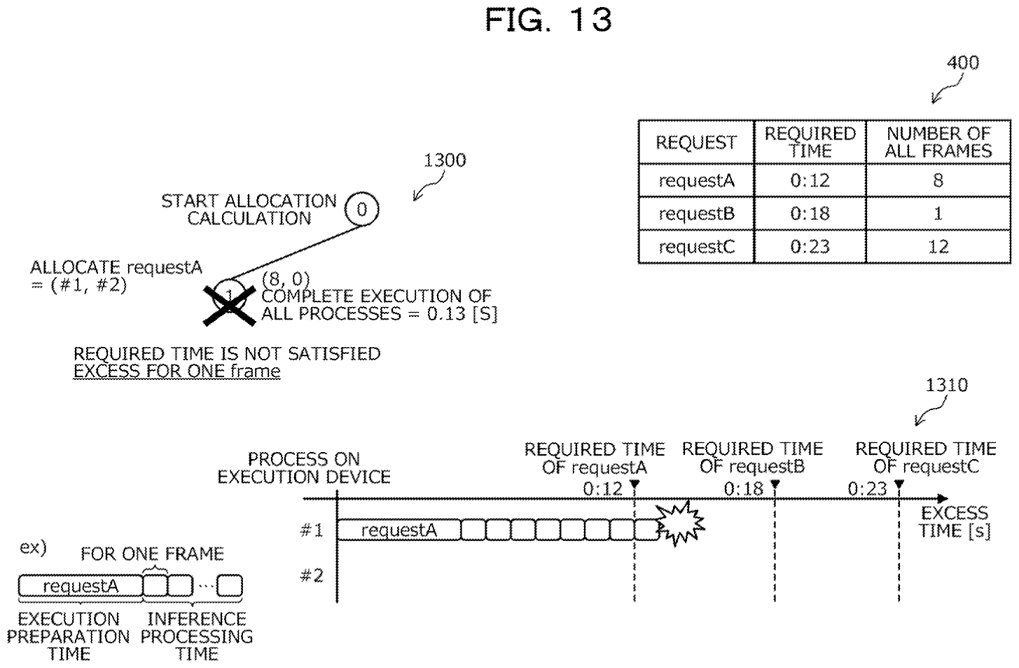

Next, operation examples of the information processing system 200 will be described with reference to FIGS. 13 to 19.

FIGS. 13 to 19 are explanatory diagrams illustrating operation examples of the information processing system 200. In the example of FIGS. 13 to 19, the inference process a of requestA, the inference process b of requestB, and an inference process c of requestC are present.

The required time of the inference process a is 0:12. The total number of frames in the inference process a is 8. The total number of frames indicates how many frames the inference process calculates. The required time of the inference process b is 0:18. The total number of frames in the inference process b is 1. The required time of the inference process c is 0:23. The total number of frames in the inference process c is 12. The required time and the total number of frames of each inference process are stored using the inference execution request management table 400.

Furthermore, in the examples of FIGS. 13 to 19, it is assumed that one execution device 201 is present. The execution device 201 can execute two inference processes in parallel. For convenience of description, it is assumed that the execution device 201 prepares the execution process frames #1 and #2, and one inference process can be executed in each of the execution process frames #1 and #2. The substance of the execution process frame is, for example, some sort of processing process. The processing process operates as an inference process when the inference model to be read and the frame to be calculated are designated.

In FIG. 13, the information processing device 100 sorts the inference processes of the inference process a, the inference process b, and the inference process c in ascending order of the remaining time to the required time and determines the priority of allocation of each inference process. The information processing device 100 determines the priority of allocation of each inference process such that the allocation of the inference process having the shorter remaining time has a higher priority.

The information processing device 100 generates root 0 of a tree structure 1300. The information processing device 100 sets the inference process a having the highest priority as the allocation target. The information processing device 100 generates the node 1 indicating the result of allocating the inference process a set as the processing target to the execution process frame #1 of the execution device 201, and connects the node 1 to the lower level of the root 0. The information processing device 100 calculates the time needed 0.13 [s] to complete execution of all the allocated inference processes at the node 1.

As illustrated by reference numeral 1310, the information processing device 100 deletes the node 1 because the calculated time needed 0.13 [s] exceeds the required time 0:12 [s] set for the inference process a. The information processing device 100 specifies the time needed 0.1 [s] for the calculation for one frame as the excess time, and stores the time needed, using the required time excess information management table 800. Here, the tree structure 1300 is in the state illustrated in FIG. 13.

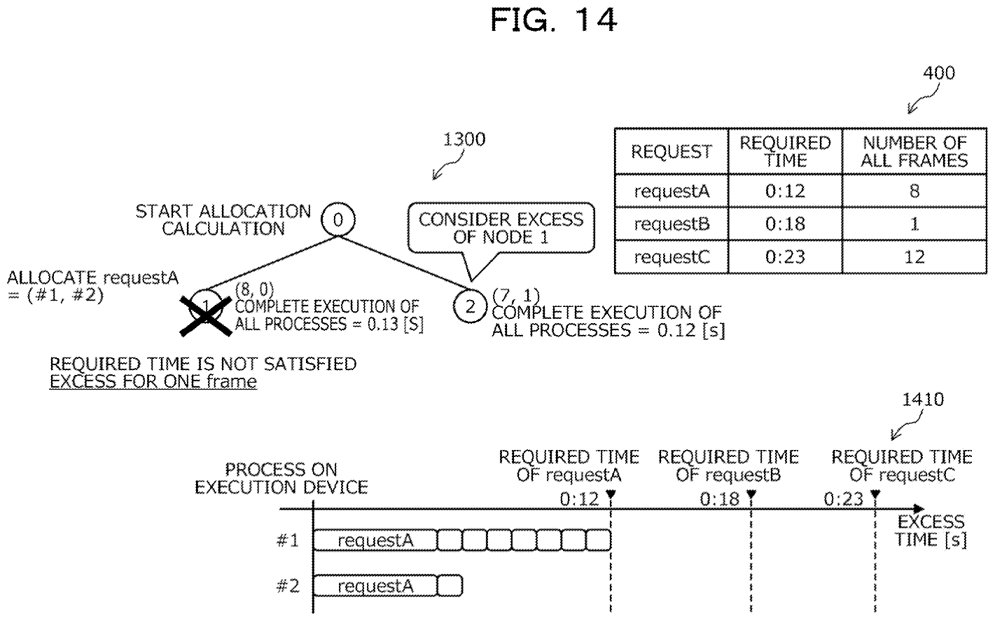

As a result, the information processing device 100 can delete the node 1 to terminate the search of the lower level of the node 1, and can reduce the processing amount. Furthermore, the information processing device 100 can grasp how many frames of calculation have not been completed by the required time, and can obtain a guideline for reallocating the inference process a. Next, description of FIG. 14 will be given.

In FIG. 14, since the information processing device 100 has deleted the node 1, the information processing device 100 reallocates the inference process a so as to execute the inference process a set as the processing target in parallel. For example, the information processing device 100 allocates the inference process a that performs calculation for seven frames to the execution process frame #1 of the execution device 201, and generates the node 2 indicating the result of allocating the inference process a that performs calculation for one frame to the execution process frame #2 of the execution device 201. The information processing device 100 connects the generated node 2 to the lower level of the root 0. The information processing device 100 calculates the time needed 0.12 [s] to complete execution of all the allocated inference processes at the node 2.

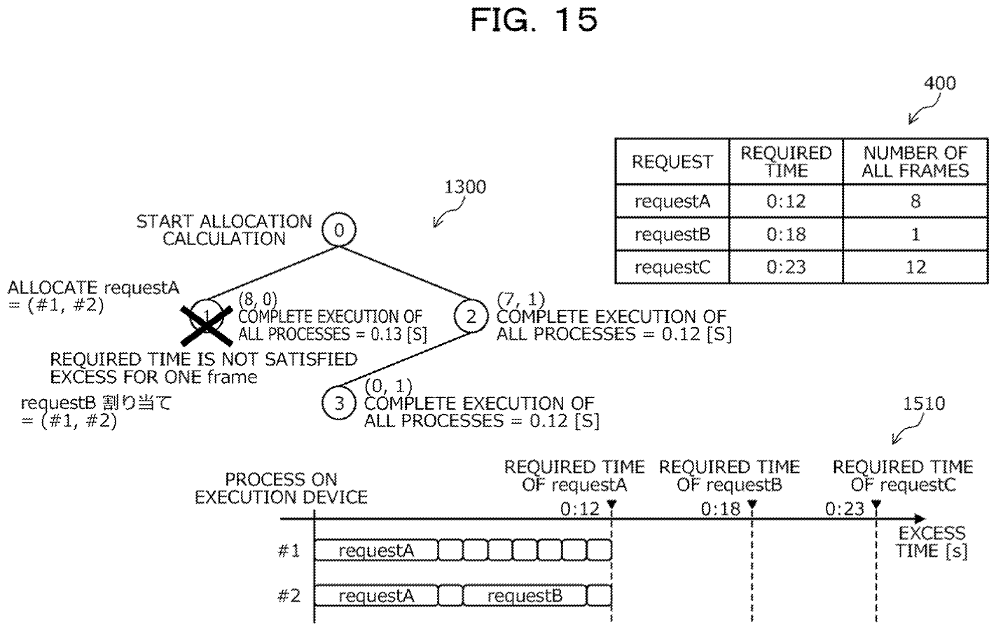

As illustrated by reference numeral 1410, the information processing device 100 determines the node 2 because the calculated time needed 0.12 [s] does not exceed the required time 0:12 [s] set for the inference process a. Here, the tree structure 1300 is in the state illustrated in FIG. 14. As a result, the information processing device 100 can allocate the inference process a so as to complete the execution of the inference process a by the required time. Next, description of FIG. 15 will be given.

In FIG. 15, the information processing device 100 sets the inference process b having the next highest priority as the allocation target. The information processing device 100 generates the node 3 indicating the result of allocating the inference process b set as the processing target to the execution process frame #2 of the execution device 201 having a relatively large free resource, and connects the node 3 to the lower level of the node 2. The information processing device 100 calculates the time needed 0.12 [s] to complete execution of all the allocated inference processes at the node 3.

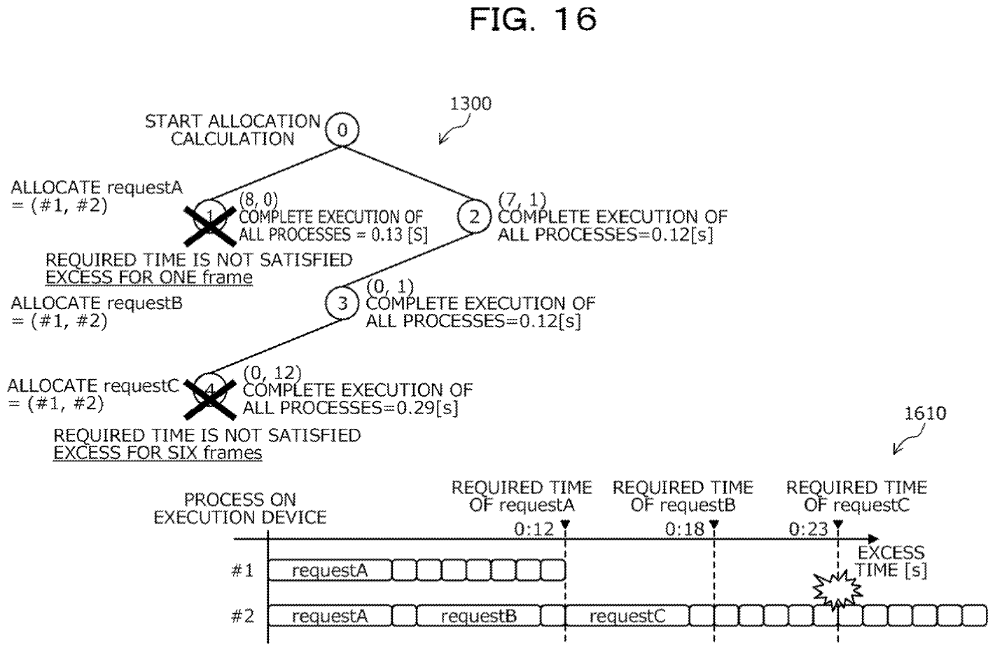

As illustrated by reference numeral 1510, the information processing device 100 determines the node 3 because the calculated time needed 0.12 [s] does not exceed the required time 0:18 [s] set for the inference process b. Here, the tree structure 1300 is in the state illustrated in FIG. 15. As a result, the information processing device 100 can sequentially allocate the inference process from the one having the highest priority such that the required time is unlikely to be exceeded. Next, description of FIG. 16 will be given.

In FIG. 16, the information processing device 100 sets the inference process c having the next highest priority as the allocation target. The information processing device 100 generates a leaf 4 indicating the result of allocating the inference process c set as the processing target to the execution process frame #2 of the execution device 201, and connects the leaf 4 to the lower level of the node 3. The information processing device 100 calculates the time needed 0.29 [s] to complete execution of all the allocated inference processes at the leaf 4.

As illustrated by reference numeral 1610, the information processing device 100 deletes the leaf 4 because the calculated time needed 0.29 [s] exceeds the required time 0:23 [s] set for the inference process c. The information processing device 100 specifies the time needed 0.6 [s] for the calculation for six frames as the excess time, and stores the time needed, using the required time excess information management table 800. Here, the tree structure 1300 is in the state illustrated in FIG. 16.

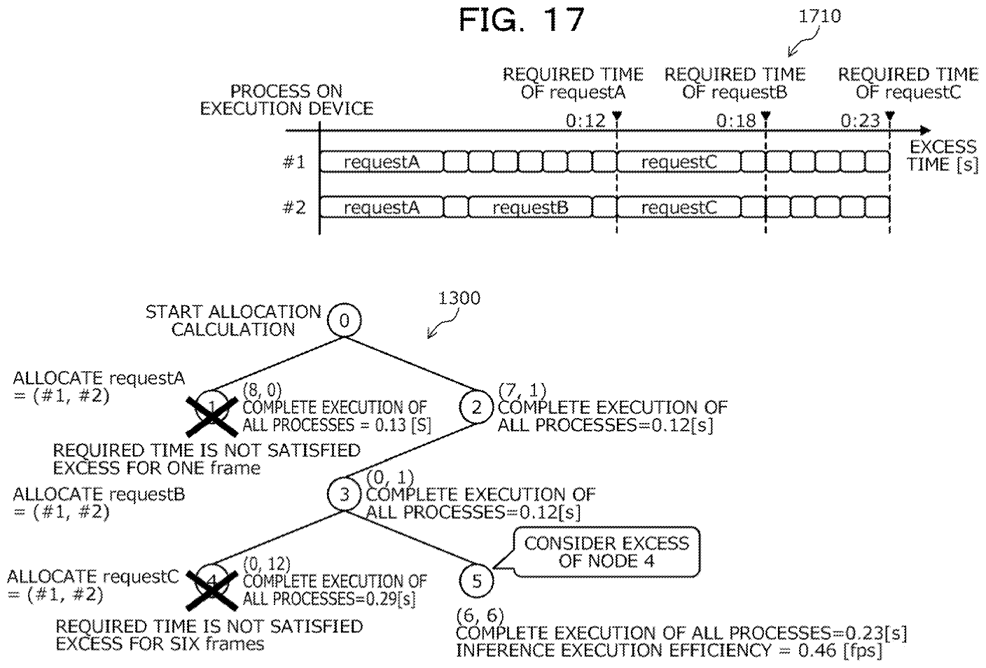

As a result, the information processing device 100 deletes the leaf 4 without adopting the allocation pattern by which the execution of the inference process specified by the route from the root 0 to the leaf 4 is not completed by the required time, as a tentative solution. The tentative solution is an allocation pattern that is currently considered appropriate. Next, description of FIG. 17 will be given.

In FIG. 17, since the information processing device 100 has deleted the leaf 4, the information processing device 100 reallocates the inference process c so as to execute the inference process c set as the processing target in parallel. For example, the information processing device 100 allocates the inference process c that performs calculation for six frames to the execution process frame #1 of the execution device 201, and generates a leaf 5 indicating the result of allocating the inference process c that performs calculation for six frames to the execution process frame #2 of the execution device 201. The information processing device 100 connects the generated leaf 5 to the lower level of the node 3. The information processing device 100 calculates the time needed 0.23 [s] to complete execution of all the allocated inference processes at the leaf 5.

As illustrated by reference numeral 1710, the information processing device 100 determines the leaf 5 because the calculated time needed 0.23 [s] does not exceed the required time 0:23 [s] set for the inference process c. The information processing device 100 calculates execution efficiency P_{throughput} [fps] for the allocation pattern specified by the route from the root 0 to the leaf 5 according to the following equation (1). The execution efficiency is the ratio of the total number of frames calculated in the inference process to the total occupied time of the inference process execution device 201 of the inference process in the execution device 201.

P_{throughput}=ΣᵢXᵢ/ΣⱼₖF(xᵢⱼₖ) (1)

i is a number of the inference process. j is a number of the execution process frame. k is a number of the execution device 201. Xᵢ is a total number of frames calculated by the i-th inference process. xᵢⱼₖ is the number of frames calculated by the i-th inference process allocated to the j-th execution process frame in the k-th execution device 201. F (xᵢⱼₖ) is the occupied time by the k-th execution device 201 by the i-th inference process allocated to the j-th execution process frame. Specifically, F (xᵢⱼₖ) is defined by the following equation (2).

F(xᵢⱼₖ)=aₚᵣₑ·dᵢₖ·Tₚᵣₑ+a_{inf}·xᵢⱼₖ·T_{inf} (2)

aₚᵣₑ is the execution preparation time increase rate. aₚᵣₑ is the execution preparation time increase rate indicating how much the execution preparation time of each inference process increases when two inference processes are executed in parallel in the execution device 201, for example. a_{inf} is the inference processing time increase rate. a_{inf} is the inference processing time increase rate indicating how much the inference processing time of each inference process increases when two inference processes are executed in parallel in the execution device 201, for example. Tₚᵣₑ is the execution preparation time. T_{inf} is the inference processing time.

dᵢₖ is flag information indicating whether the inference model used in the i-th inference process has already been read by the k-th execution device 201 at the time of allocation. The flag information of 1 indicates that the flag information has already been read. The flag information of 0 indicates that the flag information has not been read yet. In the case of dᵢₖ=0, the inference process using the already read inference model can omit initialization and reading of the inference model. In other words, in the case of dᵢₖ=0, the execution preparation time for the inference process using the already read inference model is 0.

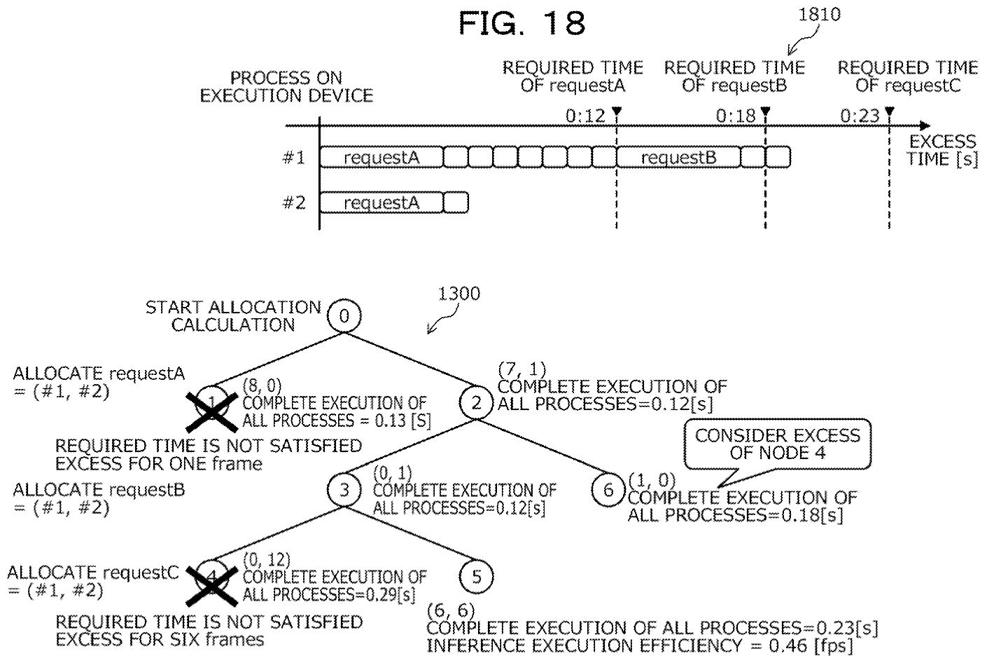

Here, the information processing device 100 calculates the execution efficiency of 0.46 [fps]. The information processing device 100 sets the allocation pattern specified by the route from the root 0 to the leaf 5 as the tentative solution. Here, the tree structure 1300 is in the state illustrated in FIG. 17. As a result, the information processing device 100 can obtain the execution efficiency as a guideline for evaluating how appropriate the tentative solution is as the allocation pattern. Next, description of FIG. 18 will be given.

In FIG. 18, the information processing device 100 determines whether the inference process to be allocated to a lower level of the node has a past record of exceeding the required time at the node traced from the leaf 5 to the upper level. Here, the information processing device 100 determines that the inference process c to be allocated to a lower level of the node 3 has a past record of exceeding the required time at the node 3 traced from the leaf 5 to the upper level.

The information processing device 100 generates a node 6 indicating the result of allocating the inference process b to a position different from the position allocated at the node 3 without changing the degree of parallelism of the inference process b at the node 3. For example, the information processing device 100 generates the node 6 indicating the result of allocating the inference process b to the execution process frame #1 having the second largest free resource after the execution process frame #2 allocated at the node 3 without changing the degree of parallelism of the inference process b. The information processing device 100 connects the generated node 6 to the lower level of the node 2 so as to be in the same hierarchy as the node 3. The information processing device 100 calculates the time needed 0.18 [s] to complete execution of all the allocated inference processes at the node 6.

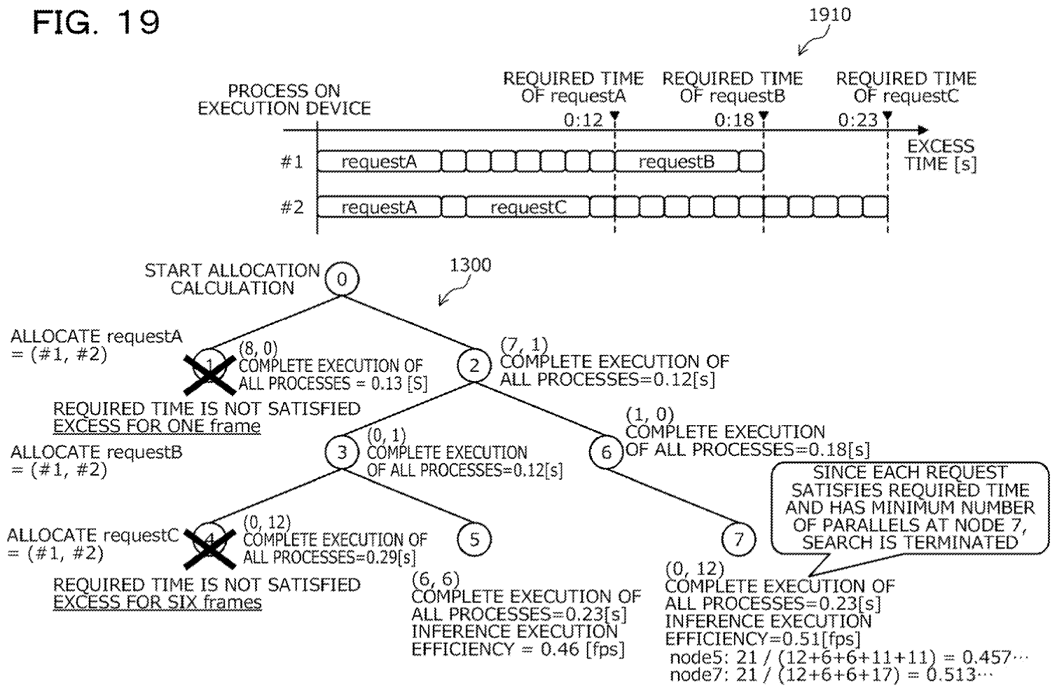

As illustrated by reference numeral 1810, the information processing device 100 determines the node 6 because the calculated time needed 0.18 [s] does not exceed the required time 0:18 [s] set for the inference process b. Here, the tree structure 1300 is in the state illustrated in FIG. 18. As a result, the information processing device 100 can search for whether there is an allocation pattern different from the tentative solution without exceeding the required time. Next, description of FIG. 19 will be given.

In FIG. 19, the information processing device 100 sets the inference process c having the next highest priority as the allocation target. The information processing device 100 generates a leaf 7 indicating the result of allocating the inference process c set as the processing target to the execution process frame #2 of the execution device 201, and connects the leaf 7 to the lower level of the node 6. The information processing device 100 calculates, in leaf 7, the time needed to complete the execution of all the assigned inference processes, 0.23 [s].

As illustrated by reference numeral 1910, the information processing device 100 determines the leaf 7 because the calculated time needed 0.23 [s] does not exceed the required time 0:23 [s] set for the inference process c. The information processing device 100 calculates execution efficiency P_{throughput} [fps] for the allocation pattern specified by the route from the root 0 to the leaf 7 according to the above equation (1).

Here, the information processing device 100 calculates the execution efficiency of 0.51 [fps]. The information processing device 100 determines whether the allocation pattern specified by the route from the root 0 to the leaf 7 has higher execution efficiency than the tentative solution. Here, since the allocation pattern specified by the route from the root 0 to the leaf 7 has higher execution efficiency than the tentative solution, the information processing device 100 sets the allocation pattern specified by the route from the root 0 to the leaf 7 as a new tentative solution. Here, the tree structure 1300 is in the state illustrated in FIG. 19.

Here, the information processing device 100 determines the tentative solution as the appropriate allocation pattern and terminates the search because the number of parallels of each inference process is minimized and the required time set for each inference process is not exceeded. For example, another solution having a larger number of parallels than the tentative solution does not need to be searched because the another solution is a solution that does not use the execution device 201 more efficiently than the tentative solution. As a result, the information processing device 100 can obtain the appropriate allocation pattern and can efficiently use the execution device 201.

The information processing device 100 can obtain the appropriate allocation pattern while suppressing an increase in the number of execution devices that read the same inference model, for example. Therefore, the information processing device 100 can reduce the number of times of the initialization and reading of the inference model in each execution device, and can efficiently use the execution device 201.

### Overall Processing Procedure

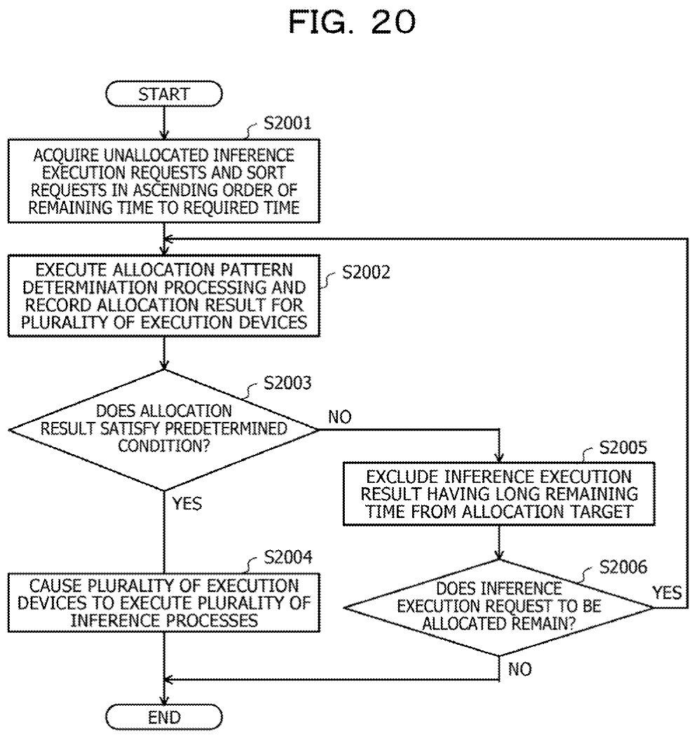

Next, an example of an overall processing procedure executed by the information processing device 100 will be described with reference to FIG. 20. The overall processing is implemented by, for example, the CPU 301, the storage region of the memory 302, the recording medium 305, or the like, and the network I/F 303 illustrated in FIG. 3.

FIG. 20 is a flowchart illustrating an example of an overall processing procedure. In FIG. 20, the information processing device 100 refers to the inference execution request management table 400, acquires unallocated inference execution requests, sorts them in ascending order of the remaining time to the required time, and sets the inference execution requests to be allocated (step S2001).

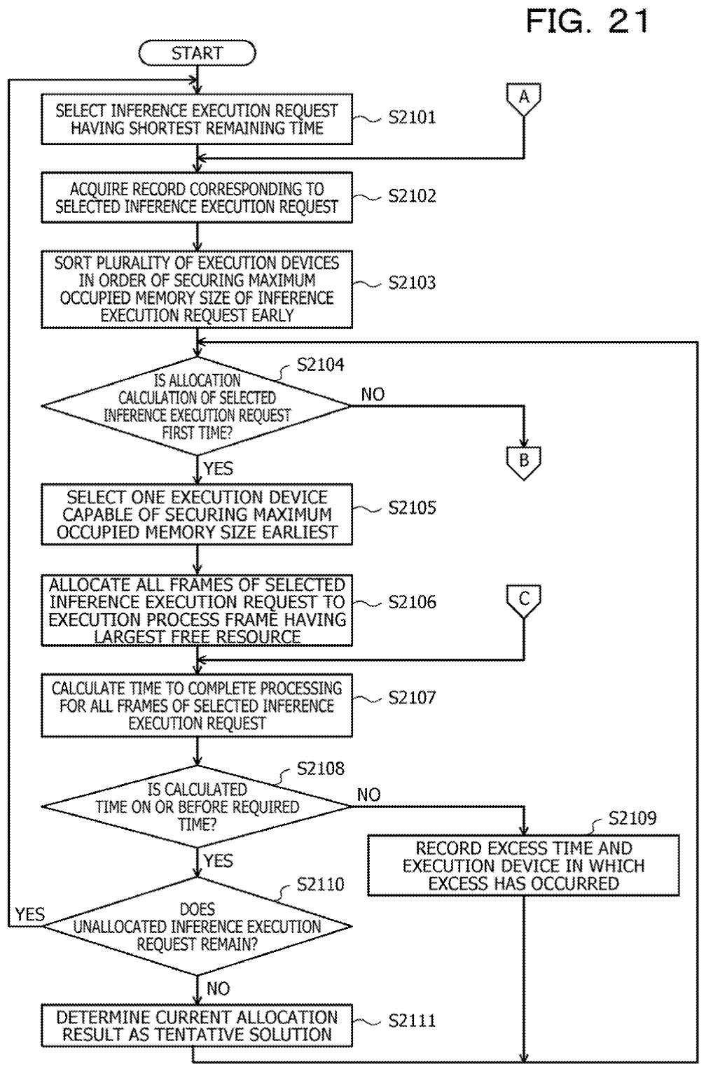

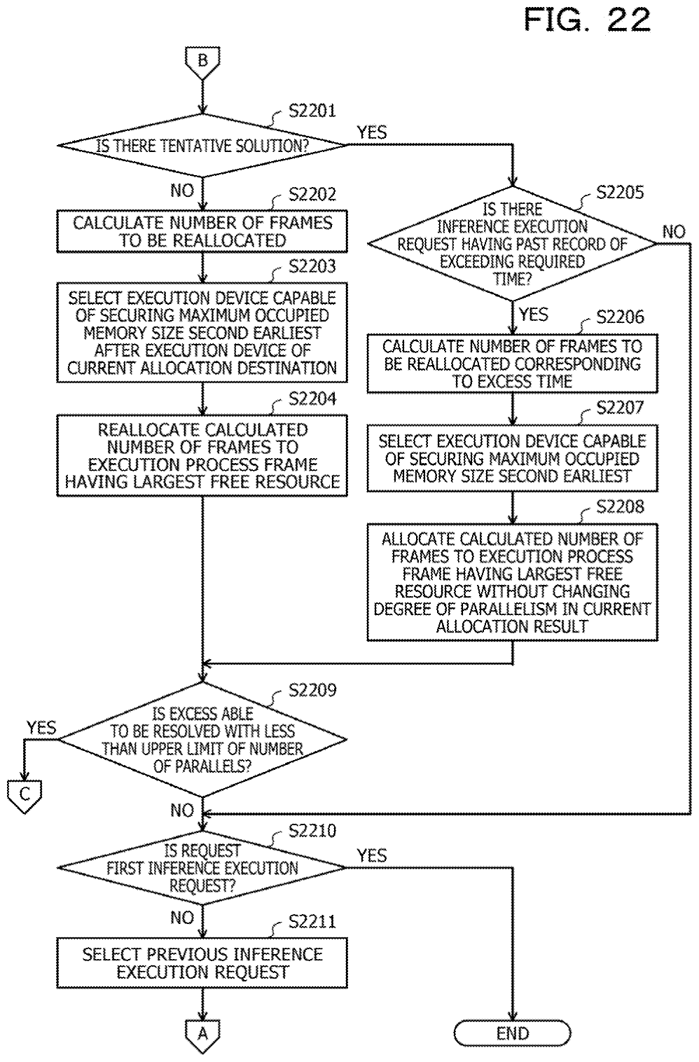

Next, the information processing device 100 executes allocation pattern determination processing to be described below with reference to FIGS. 21 and 22, and records the allocation results for the plurality of execution devices 201 in the allocation result management table 700 (step S2002). Then, the information processing device 100 determines whether the allocation result satisfies a predetermined condition (step S2003). The predetermined condition is that the time when the execution of the inference process designated by each inference execution request is completed and all the frames designated by the inference execution request are completed is on or before the required time designated by the inference execution request in the allocation result.

Here, in the case where the predetermined condition is satisfied (step S2003: Yes), the information processing device 100 proceeds to the processing of step S2004. On the other hand, in the case where the predetermined condition is not satisfied (step S2003: No), the information processing device 100 proceeds to the processing of step S2005.

In step S2004, the information processing device 100 allocates the plurality of inference processes to the plurality of execution devices 201 according to the allocation result, and causes the plurality of execution devices 201 to execute the plurality of inference processes (step S2004). Then, the information processing device 100 terminates the overall processing.

In step S2005, the information processing device 100 refers to the required time excess information management table 800 and excludes the inference execution request having the longest remaining time to the required time from the allocation target (step S2005). Next, the information processing device 100 determines whether the inference execution request to be allocated remains (step S2006).

Here, in the case where the inference execution request to be allocated remains (step S2006: Yes), the information processing device 100 returns to the processing of step S2002. On the other hand, in the case where the inference execution request to be allocated does not remain (step S2006: No), the information processing device 100 terminates the overall processing. As a result, the information processing device 100 efficiently uses the plurality of execution devices 201 and can allocate the plurality of inference processes to the plurality of execution devices 201 such that the time to complete the execution of each inference process falls on or before the required time.

Furthermore, the information processing device 100 can reduce the number of inference execution requests to be allocated if the time to complete the execution of any inference process does not fall on or before the required time. Then, the information processing device 100 can allocate the plurality of inference processes to the plurality of execution devices 201 such that the time to complete the execution of a relatively large number of inference processes falls on or before the required time.

### Allocation Pattern Determination Processing Procedure

Next, an example of an allocation pattern determination processing procedure executed by the information processing device 100 will be described with reference to FIGS. 21 and 22. The allocation pattern determination processing is implemented by, for example, the CPU 301, the storage region of the memory 302, the recording medium 305, or the like, and the network I/F 303 illustrated in FIG. 3.

FIGS. 21 and 22 are flowcharts illustrating an example of the allocation pattern determination processing procedure. In FIG. 21, the information processing device 100 selects the inference execution request having the shortest remaining time among the unselected unallocated inference execution requests on the basis of the sorting result in step S2001 in FIG. 20 (step S2101).

Next, the information processing device 100 refers to the inference execution request management table 400 and acquires the record corresponding to the selected inference execution request (step S2102). Then, the information processing device 100 acquires the maximum exclusive memory size of the selected inference execution request on the basis of the acquired record. The information processing device 100 refers to the inference model execution profile management table 600 and acquires the maximum exclusive memory size of the acquired inference execution request. The information processing device 100 refers to the execution device resource information management table 500 and sorts the plurality of execution devices 201 in order of securing the maximum exclusive memory size of the acquired inference execution request early (step S2103).

Next, the information processing device 100 determines whether allocation calculation of the selected inference execution request is the first time (step S2104). The allocation calculation is to allocate the inference process designated by the inference execution request and the frame to be calculated by the inference process to any execution process frame of any execution device 201. The first time is, for example, the first time on the route from the root to the current node.

Here, in the case where the allocation calculation is not the first time (step S2104: No), the information processing device 100 proceeds to the processing of step S2201 of FIG. 22. On the other hand, in the case where the allocation calculation is the first time (step S2104: Yes), the information processing device 100 proceeds to the processing of step S2105.

In step S2105, the information processing device 100 selects one execution device 201 that can secure the maximum exclusive memory size earliest (step S2105). Next, the information processing device 100 allocates all the frames of the selected inference execution request to the execution process frame having the largest free resource among the execution process frames in the selected execution device 201 (step S2106). The largest free resource means that the time to complete the execution of the inference process allocated to the execution process frame is the earliest.

Then, the information processing device 100 refers to the inference model execution profile management table 600 and acquires the occupied time and the allocated number of frames on the selected execution device 201. The information processing device 100 calculates the time when processing of all the frames designated by the selected inference execution request is completed on the basis of the acquired occupied time and the number of allocated frames on the execution device 201 (step S2107).

Next, the information processing device 100 determines whether the calculated time is on or before the required time (step S2108). Here, in a case where the time is on or before the required time (step S2108: Yes), the information processing device 100 proceeds to the processing of step S2110. On the other hand, in the case where the time is not on or before the required time (step S2108: No), the information processing device 100 proceeds to the processing of step S2109.

In step S2109, the information processing device 100 records the excess time and the execution device 201 in which the excess has occurred in the required time excess information management table 800 in association with the inference requiring request (step S2109). As a result, the information processing device 100 records that there is a past record that the calculated time has exceeded the required time regarding the inference requiring request. Then, the information processing device 100 returns to the processing in step S2104.

In step S2110, the information processing device 100 determines whether there is an unallocated inference execution request (step S2110). Here, in the case where the inference execution request remains (step S2110: Yes), the information processing device 100 returns to the processing of step S2101. On the other hand, in the case where no inference execution request remains (step S2110: No), the information processing device 100 moves onto the processing of step S2111.

In step S2111, the information processing device 100 calculates the inference execution efficiency in the current allocation result and determines the current allocation result as the tentative solution in the case where the calculated execution efficiency is more favorable than the execution efficiency in the past tentative solution (step S2111). Then, the information processing device 100 returns to the processing in step S2104.

In FIG. 22, the information processing device 100 determines whether there is a tentative solution (step S2201). Here, in the case where there is a tentative solution (step S2201: Yes), the information processing device 100 proceeds to the processing of step S2205. On the other hand, in the case where there is no tentative solution (step S2201: No), the information processing device 100 proceeds to the processing of step S2202.

In step S2202, the information processing device 100 refers to the inference model execution profile management table 600 and the required time excess information management table 800, and calculates the number of frames to be reallocated to resolve the required time excess (step S2202).

Next, the information processing device 100 selects the execution device 201 that can secure the maximum exclusive memory size second earliest after the execution device 201 of the current allocation destination (step S2203). Then, the information processing device 100 reallocates the calculated number of frames to the execution process frame having the largest free resource among the execution process frames in the selected execution device 201 (step S2204). Except for the frames to be reallocated, for example, the frames may remain allocated to the execution device 201 of the current allocation destination. At this time, the information processing device 100 may allocate the calculated number of frames to the execution process frame having the largest free resource or may not allocate the calculated number of frames in the case where the excess is not able to be resolved. Then, the information processing device 100 proceeds to the processing of step S2209.

In step S2205, the information processing device 100 refers to the required time excess information management table 800, and determines whether there is an inference execution request having the past record of exceeding the required time in the inference execution requests after the selected inference execution request (step S2205). An inference execution request after a certain inference execution request is an inference execution request positioned after the certain inference execution request in the sequence of a plurality of sorted inference execution requests.

Here, in the case where there is no inference execution request having the past record of exceeding the required time (step S2205: No), the information processing device 100 moves onto the processing of step S2210. On the other hand, in the case where there is the inference execution request having the past record of exceeding the required time (step S2205: Yes), the information processing device 100 moves onto the processing of step S2206.

In step S2206, the information processing device 100 refers to the required time excess information management table 800, acquires the inference execution request having the past record of exceeding the required time, and calculates the number of frames to be reallocated corresponding to the excess time (step S2206). Next, the information processing device 100 selects the execution device 201 that can secure the maximum exclusive memory size second earliest after the execution device 201 of the current allocation destination (step S2207).

Then, the information processing device 100 allocates the calculated number of frames to the execution process frame having the largest free resource among the execution process frames in the selected execution device 201 without changing the parallelism in the current allocation result (step S2208). At this time, the information processing device 100 may allocate the calculated number of frames to the execution process frame having the largest free resource or may not allocate the calculated number of frames in the case where the excess is not able to be resolved. Then, the information processing device 100 proceeds to the processing of step S2209.

In step S2209, the information processing device 100 determines whether the excess can be resolved by allocating the inference processes in parallel with less than the upper limit of the number of parallels (step S2209). The upper limit of the number of parallels indicates how many inference processes can be allocated in a distributed manner. The upper limit of the number of parallels is, for example, a sum of the number of inference processes that can be distributed and allocated in each execution node.

Here, in the case where there is the number of parallels that can resolve the excess by allocating the inference processes in parallel with less than the upper limit of the number of parallels (step S2209: Yes), the information processing device 100 returns to the processing of step S2107 of FIG. 21. On the other hand, in the case where there is no number of parallels that can resolve the excess by allocating the inference processes in parallel with less than the upper limit of the number of parallels (step S2209: No), the information processing device 100 moves onto the processing of step S2210.

In step S2210, the information processing device 100 determines whether the selected inference execution request is the first inference execution request (step S2210). Here, in the case where the selected inference execution request is the first inference execution request (step S2210: Yes), the information processing device 100 terminates the allocation pattern determination processing. On the other hand, in the case where the selected inference execution request is not the first inference execution request (step S2210: No), the information processing device 100 proceeds to the processing of step S2211.

In step S2211, the information processing device 100 selects the inference execution request immediately before the selected inference execution request (step S2211). Then, the information processing device 100 returns to the processing in step S2102 of FIG. 21.

Here, the information processing device 100 may shuffle some steps in each of the flowcharts of FIGS. 20 to 22 in the processing order and execute the processing. For example, the processing order of steps S2005 and S2006 may be swapped. Furthermore, the information processing device 100 may omit processing of some steps in each of the flowcharts of FIGS. 20 to 22.

As described above, according to the information processing device 100, the profile information enabling specification of the time needed to prepare for execution of each processing of a plurality of pieces of processing and the time needed to execute the processing can be obtained. According to the information processing device 100, the node from the root to the leaf can be searched such that the execution of each processing can be completed within the time limit set for the processing in the tree structure by referring to the acquired profile information. Thereby, the information processing device 100 can determine the arrangement pattern of the plurality of pieces of processing for one or more arithmetic units, which can maximize the execution efficiency for the plurality of pieces of processing. Therefore, the information processing device 100 can allocate the plurality of pieces of processing to the one or more arithmetic units such that the execution of each processing can be completed within the time limit set for the processing while efficiently using the one or more arithmetic units.

According to the information processing device 100, the node at which the execution of the processing arranged in one or more arithmetic units among the plurality of pieces of processing can be completed within the time limit set for the processing can be traced from the root in the tree structure by referring to the acquired profile information. According to the information processing device 100, the execution efficiency for the plurality of pieces of processing can be calculated on the basis of the cumulative time needed for preparation for execution and for execution of the each processing in each leaf reachable by being traced from the root. According to the information processing device 100, the arrangement pattern of the plurality of pieces of processing can be determined on the basis of the leaf having the maximum calculated execution efficiency. Thereby, the information processing device 100 can evaluate how appropriate the arrangement pattern is, which is specified from each leaf. Therefore, the information processing device 100 can easily determine the appropriate arrangement pattern.

According to the information processing device 100, the arrangement pattern of the plurality of pieces of processing can be determined by searching for the node from the root to the leaf such that the execution of each processing can be completed within the time limit set for the processing while generating the tree structure. As a result, the information processing device 100 can execute the generation and the search of the tree structure in parallel.

According to the information processing device 100, the root can be set as the target node in the initial state. According to the information processing device 100, the operation of connecting a new node representing the position where any one piece of processing of the plurality of pieces of processing is arranged to the lower level of a certain node set as the target node, and setting the new node as the target node, can be repeated. As a result, the information processing device 100 can generate the tree structure.

According to the information processing device 100, when the operation is repeated, whether the execution of the processing arranged at the position represented by a certain node set as the target node can be completed within the time limit set for the processing can be determined. According to the information processing device 100, in the case where the execution of the processing is not able to be completed, a new node representing a position where the processing is arranged, and that is different from the position represented by the certain node, is connected to the lower level of the parent of the certain node, and the new node can be set as the target node. According to the information processing device 100, a certain node can be deleted. As a result, the information processing device 100 can grasp that even if the lower level of a certain node is searched, the appropriate arrangement pattern by which the execution of each processing can be completed within the time limit set for the processing is not able to be found. Since the information processing device 100 does not find the appropriate arrangement pattern even if searching the lower level of the certain node, the information processing device 100 can delete the certain node and terminate the search from the certain node to the lower level, and can reduce the processing amount.

According to the information processing device 100, when the operation is repeated, whether a certain node set as the target node is a leaf and whether the execution of the processing arranged at the position represented by the certain node can be completed within the time limit set for the processing can be determined. According to the information processing device 100, in the case where the certain node is not a leaf and the execution of the processing can be completed, a new node representing a position where processing different from the processing is arranged can be connected to the lower level of the certain node, and the new node can be set as the target node. As a result, the information processing device 100 can connect a new node to the lower level of a certain node if there is a possibility of finding the appropriate arrangement pattern by which the execution of each processing can be completed within the time limit set for the processing at the lower level of the certain node. Therefore, the information processing device 100 can easily find the appropriate arrangement pattern.

According to the information processing device 100, when the operation is repeated, whether a certain node set as the target node is a leaf and whether the execution of the processing arranged at the position represented by the certain node can be completed within the time limit set for the processing can be determined. According to the information processing device 100, in the case where the certain node is a leaf and the execution of the processing can be completed, the execution efficiency for the plurality of pieces of processing can be calculated at the certain node. According to the information processing device 100, the arrangement pattern of the plurality of pieces of processing for one or more arithmetic units can be determined on the basis of the leaf having the maximum calculated execution efficiency. As a result, the information processing device 100 can evaluate how appropriate the arrangement pattern specified from the leaf is on the basis of the execution efficiency and can easily determine the appropriate arrangement pattern.

According to the information processing device 100, a new node representing the position where any one piece of processing to which a relatively short time limit is set among unarranged pieces of processing included in the plurality of pieces of processing can be connected to the lower level of a certain node set as the target node. As a result, the information processing device 100 can arrange the plurality of pieces of processing in order so that the execution of each processing can be easily completed within the time limit set for the processing.

According to the information processing device 100, when the operation is repeated, whether the execution of the processing arranged at the position represented by a certain node set as the target node can be completed within the time limit set for the processing can be determined. According to the information processing device 100, in the case where the execution of the processing is not able to be completed, a new node representing a position where the processing is arranged in a distributed manner such that the execution of the processing can be completed within the time limit set for the processing can be connected to the lower level of the parent of the certain node. As a result, the information processing device 100 can determine the arrangement pattern in consideration of the case where the processing is arranged in a distributed manner. The information processing device 100 can facilitate the execution of each processing to be easily completed within the time limit set for the processing.

According to the information processing device 100, the time needed for initialization and reading of the model to be used for executing each processing can be adopted as the time needed to prepare for execution of the processing. As a result, the information processing device 100 accurately determine whether the execution of each processing can be completed within the time limit set for the processing in consideration of the time needed for initialization and reading of the model to be used for execution of the processing.

Note that the information processing method described in the present embodiment may be implemented by executing a prepared program on a computer such as a personal computer (PC) or a workstation. The information processing program described in the present embodiment is executed by being recorded on a computer-readable recording medium and being read from the recording medium by the computer. The recording medium is a hard disk, a flexible disk, a compact disc (CD)-ROM, a magneto-optical disc (MO), a digital versatile disc (DVD), or the like. Furthermore, the information processing program described in the present embodiment may be distributed via a network such as the Internet.

All examples and conditional language provided herein are intended for the pedagogical purposes of aiding the reader in understanding the invention and the concepts contributed by the inventor to further the art, and are not to be construed as limitations to such specifically recited examples and conditions, nor does the organization of such examples in the specification relate to a showing of the superiority and inferiority of the invention. Although one or more embodiments of the present invention have been described in detail, it should be understood that the various changes, substitutions, and alterations could be made hereto without departing from the spirit and scope of the invention.

What is claimed is:

1. An information processing device comprising:
a memory; and
a processor coupled to the memory, the processor being configured to perform first processing, the first processing including:
acquiring, for each processing of a plurality of pieces of processing to be executed using different models, profile information that enables specification of a time needed to prepare for execution of that processing and a time needed to execute that processing; and
determining, in arranging the plurality of pieces of processing for one or more arithmetic units by using the acquired profile information, an arrangement pattern of the plurality of pieces of processing for the one or more arithmetic units, the arrangement pattern being capable of maximizing execution efficiency for the plurality of pieces of processing, the determining of the arrangement pattern including searching for a node from a root to a leaf such that the execution of the each processing is able to be completed within a time limit set for that processing, in a tree structure in which the node that represents a position where processing included in the plurality of pieces of processing is arranged is connected from the root to a lower level, the three structure being formed such that a larger number of pieces of processing has been arranged as a hierarchy is deeper.

2. The information processing device according to claim 1, wherein
the first processing further includes:
calculating the execution efficiency for the plurality of pieces of processing on the basis of a cumulative time needed for preparation for execution and for execution of the each processing at each leaf reachable by tracing, from the root, a node at which the execution of the processing arranged in the one or more arithmetic units among the plurality of pieces of processing is able to be completed within the time limit set for the processing in the tree structure, by reference to the acquired profile information; and
determining the arrangement pattern of the plurality of pieces of processing on the basis of a leaf that has the maximum calculated execution efficiency.

3. The information processing device according to claim 1, wherein
the first processing further includes
determining the arrangement pattern of the plurality of pieces of processing by searching for the node from the root to a leaf such that the execution of the each processing is able to be completed within the time limit set for the processing while generating the tree structure, by referring to the acquired profile information.

4. The information processing device according to claim 3, wherein
the root is set as a target node in an initial state, and
the first processing includes generating the tree structure by repeating an operation of connecting a new node that represents a position where any one piece of processing of the plurality of pieces of processing is arranged to a lower level of a certain node set as the target node, and setting the new node as the target node.

5. The information processing device according to claim 4, wherein,
the first processing includes
in the repeating of the operation, in a case where execution of processing arranged at a position represented by the certain node set as the target node is not able to be completed within a time limit set for the processing:
connecting a new node that represents a first position to a lower level of parent of the certain node, the first position being a position where the processing is arranged and being different from a position represented by the certain node;
setting the new node as the target node; and
deleting the certain node.

6. The information processing device according to claim 4, wherein,
the first processing incudes
in the repeating of the operation, in a case where the certain node set as the target node is not a leaf, and the execution of processing arranged at a position represented by the certain node is able to be completed within the time limit set for the processing:
connecting a new node that represents a position where another processing different from the processing is arranged to a lower level of the certain node; and
setting the new node as the target node.

7. The information processing device according to claim 4, wherein,
the first processing includes
in the repeating of the operation, in a case where the certain node set as the target node is a leaf, and the execution of processing arranged at a position represented by the certain node is able to be completed within the time limit set for the processing:
calculating the execution efficiency for the plurality of pieces of processing at the certain node; and
determining the arrangement pattern of the plurality of pieces of processing for the one or more arithmetic units on the basis of a leaf that has the maximum calculated execution efficiency.

8. The information processing device according to claim 4, wherein
the first processing includes repeating an operation of:
connecting, to a lower level of a certain node set as the target node, a new node that represents a position where any one piece of processing to which a relatively short time limit is set among unarranged pieces of processing included in the plurality of pieces of processing; and
setting the new node as the target node.

9. An information processing method implemented by a computer, the information processing method comprising:
acquiring, for each processing of a plurality of pieces of processing to be executed using different models, profile information that enables specification of a time needed to prepare for execution of that processing and a time needed to execute that processing; and
determining, in arranging the plurality of pieces of processing for one or more arithmetic units by using the acquired profile information, an arrangement pattern of the plurality of pieces of processing for the one or more arithmetic units, the arrangement pattern being capable of maximizing execution efficiency for the plurality of pieces of processing, the determining of the arrangement pattern including searching for a node from a root to a leaf such that the execution of the each processing is able to be completed within a time limit set for that processing, in a tree structure in which the node that represents a position where processing included in the plurality of pieces of processing is arranged is connected from the root to a lower level, the three structure being formed such that a larger number of pieces of processing has been arranged as a hierarchy is deeper.

10. A system comprising;
an information processing device; and one or more arithmetic units capable of arranging processing included in a plurality of pieces of processing to be executed using different models, wherein
each arithmetic unit of the one or more arithmetic units is configured to
generate profile information that enables specification of a time needed to prepare for execution of processing to be arranged in that arithmetic unit and a time needed to execute the processing to be arranged, and transmits the profile information to the information processing device, and
the information processing device is configured to
acquire, for each processing of the plurality of pieces of processing to be executed using the different models, the profile information from each of the one or more arithmetic units; and
determine, in arranging the plurality of pieces of processing for the one or more arithmetic units by using the acquired profile information, an arrangement pattern of the plurality of pieces of processing for the one or more arithmetic units, the arrangement pattern being capable of maximizing execution efficiency for the plurality of pieces of processing, the determining of the arrangement pattern including searching for a node from a root to a leaf such that the execution of the each processing is able to be completed within a time limit set for that processing, in a tree structure in which the node that represents a position where processing included in the plurality of pieces of processing is arranged is connected from the root to a lower level, the three structure being formed such that a larger number of pieces of processing has been arranged as a hierarchy is deeper.
